(19) United States
(12) Patent Application Publication
(10) Pub. No.: US 2017/0286993 A1
(43) Pub. Date: Oct. 5, 2017

(54) Methods and Systems for Inserting Promotional Content into an Immersive Virtual Reality World

(71) Applicant: Verizon Patent and Licensing Inc., Arlington, VA (US)

(72) Inventors: Mohammad Raheel Khalid, Budd Lake, NJ (US); Ali Jaafar, Morristown, NJ (US); Dan Sun, Bridgewater, NJ (US); Christian Egeler, Basking Ridge, NJ (US)

(73) Assignee: Verizon Patent and Licensing Inc.

(21) Appl. No.: 15/087,915

(22) Filed: Mar. 31, 2016

(51) Int. Cl. G06Q 30/02; G06T 3/40; G06T 19/00

(52) U.S. Cl. CPC G06Q 30/0241; G06T 19/006; G06T 3/40; G06T 2200/04

(57) ABSTRACT

An exemplary virtual reality media system provides, for display on a display screen of a media player device associated with a user, a field of view of an immersive virtual reality world generated from and including camera-captured real-world scenery. The field of view includes content of the immersive virtual reality world and dynamically changes in response to user input provided by the user as the user experiences the immersive virtual reality world. The virtual reality media system integrates into the immersive virtual reality world a three-dimensional (“3D”) virtual object having an outer surface designated as a promotional content platform. The virtual reality media system also accesses data representative of a two-dimensional (“2D”) promotional image and maps the 2D promotional image onto the promotional content platform on the outer surface of the 3D virtual object such that the 2D promotional image is viewable as a skin of the 3D virtual object.

### BACKGROUND INFORMATION

Advances in computing and networking technology have made new forms of media content possible. For example, virtual reality media content is available that may immerse viewers (or “users”) into interactive virtual reality worlds that the users may experience by directing their attention to any of a variety of things being presented in the immersive virtual reality world at the same time. For example, at any time during the presentation of the virtual reality media content, a user experiencing the virtual reality media content may look around the immersive virtual reality world in any direction with respect to both a horizontal dimension (e.g., forward, backward, left, right, etc.) as well as a vertical dimension (e.g., up, down, etc.), giving the user a sense that he or she is actually present in and experiencing the immersive virtual reality world.

The creation and distribution of quality media content, including virtual reality media content, is often associated with significant costs and challenges. To help cover these costs, media content providers often rely on commercial sponsors willing to pay for promotional content (e.g., advertising) to be presented as part of the media content. Unfortunately, promotional paradigms and technologies established for traditional forms of media content may not work with or may not be well-optimized for virtual reality media content. For example, traditional formats for promoting content such as commercial spots (i.e., non-interactive promotional content presented during temporary interruptions to media content programs), banner ads (i.e., promotional content presented alongside media content on a static place on the screen), and other known formats may not support users' freedom to look around and/or otherwise interact with the virtual world that users experiencing virtual reality media content may expect or desire. As a result, while traditional promotional content paradigms and technologies may continue to be prevalent, they may be relatively ineffective (e.g., burdensome, annoying, etc.) for users immersed in virtual reality media content who may find it undesirable to be distracted or removed from immersive virtual reality worlds they are experiencing to view promotional material.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary configuration in which exemplary embodiments of a 360-degree camera, a virtual reality media backend system, and a media player device operate to insert promotional content into an immersive virtual reality world according to principles described herein.

FIG. 2 illustrates an exemplary virtual reality experience in which a user is presented with an exemplary field of view that includes content of an exemplary immersive virtual reality world according to principles described herein.

FIG. 3 illustrates exemplary media player devices configured to facilitate experiencing the exemplary immersive virtual reality world of FIG. 2 by a user according to principles described herein.

FIG. 4 illustrates an exemplary virtual reality media system configured to facilitate inserting promotional content into an immersive virtual reality world according to principles described herein.

FIG. 5 illustrates an exemplary configuration where the virtual reality media system of FIG. 4 is in communication with other systems and/or devices to insert promotional content into an immersive virtual reality world according to principles described herein.

FIG. 6 illustrates an exemplary two-dimensional (“2D”) promotional image that may be accessed and inserted into an immersive virtual reality world according to principles described herein.

FIG. 7 illustrates an exemplary field of view of an immersive virtual reality world that includes a generic virtual object integrated into the immersive virtual reality world according to principles described herein.

FIG. 8 illustrates exemplary display parameters assigned to the generic virtual object of FIG. 7 to integrate the generic virtual object into the immersive virtual reality world according to principles described herein.

FIGS. 9-10 illustrate exemplary three-dimensional (“3D”) virtual objects that may be integrated into the immersive virtual reality world according to principles described herein.

FIGS. 11-12 illustrate exemplary mappings of the 2D promotional image of FIG. 6 onto the 3D virtual objects of FIGS. 9-10 according to principles described herein.

FIGS. 13-14 illustrate an exemplary field of view of an immersive virtual reality world including the 3D virtual objects of FIGS. 9-10 integrated into the immersive virtual reality world with the 2D promotional image of FIG. 6 viewable as a skin of the 3D virtual objects according to principles described herein.

FIG. 15 illustrates an exemplary field of view of an immersive virtual reality world where a portion of the content of the immersive virtual reality world is dimmed to facilitate viewing promotional content by a user according to principles described herein.

FIG. 16 illustrates an exemplary configuration in which an exemplary virtual reality media backend system and an exemplary media player device operate to insert promotional content into an immersive virtual reality world according to principles described herein.

FIG. 17 illustrates an exemplary virtual reality media program metadata file according to principles described herein.

FIGS. 18-19 illustrate exemplary methods for inserting promotional content into an immersive virtual reality world according to principles described herein.

FIG. 20 illustrates an exemplary computing device according to principles described herein.

### DETAILED DESCRIPTION OF PREFERRED EMBODIMENTS

Methods and systems for inserting promotional content into an immersive virtual reality world are described herein. As will be described and illustrated below, a virtual reality media system may provide for display on a display screen of a media player device associated with a user, a field of view of an immersive virtual reality world. The immersive virtual reality world may be fully immersive in the sense that the user may not be presented with any image of the real world in which the user is located while the user is experiencing the immersive virtual reality world, in contrast to certain “augmented reality” technologies. However, while real-world scenery directly surrounding the user may not be presented together with the immersive virtual reality world, the immersive virtual reality world may, in certain examples, be generated based on data (e.g., image and/or audio data) representative of camera-captured real-world scenery rather than animated or computer-generated scenery of imaginary worlds such as those commonly generated for video games, animated entertainment programs, and so forth. For example, as will be described in more detail below, camera-captured real-world scenery may include real-world places (e.g., city streets, buildings, landscapes, etc.), real-world events (e.g., sporting events, large celebrations such as New Year's Eve or Mardi Gras, etc.), fictionalized live action entertainment (e.g., virtual reality television shows, virtual reality movies, etc.), and so forth.

The user may experience the immersive virtual reality world by way of the field of view. For example, the field of view may include content of the immersive virtual reality world (e.g., images depicting scenery and objects surrounding the user within the immersive virtual reality world). Additionally, the field of view may dynamically change in response to user input provided by the user as the user experiences the immersive virtual reality world. For example, the media player device may detect user input (e.g., moving or turning the display screen upon which the field of view is presented) that represents a request to shift additional content into the field of view in place of the previous content included within the field of view. In response, the field of view may display the additional content in place of the previous content. In this way, the field of view may essentially provide the user a “window” through which the user can easily and naturally look around the immersive virtual reality world.

The virtual reality media system may integrate into the immersive virtual reality world a virtual object (e.g., a three-dimensional (“3D”) virtual object) having an outer surface designated as a promotional content platform. In certain examples, the virtual object may be used primarily as a platform for inserting promotional content into the immersive virtual reality world and, as such, may have an outer surface designated as the promotional content platform that includes the entire (or nearly the entire) outer surface of the virtual object. In other examples, however, the virtual object may add value to the immersive virtual reality world beyond the promotional function of the virtual object and, as such, may have an outer surface designated as the promotional content platform that includes only a portion of the entire outer surface of the virtual object. Different types of virtual objects having outer surfaces designated as promotional content platforms will be described in more detail below.

The virtual reality media system may access data representative of a two-dimensional (“2D”) promotional image. For example, as will be discussed below, the 2D promotional image may be a commercial advertisement associated with a commercial sponsor and the virtual reality media system may access the data representative of the 2D promotional image from a commercial advertisement exchange service configured to distribute 2D commercial advertisements. The virtual reality media system may map the 2D promotional image onto the promotional content platform of the outer surface of the virtual object such that the 2D promotional image is viewable as a skin of the virtual object when the outer surface of the virtual object is located within the field of view of the immersive virtual reality world.

Methods and systems for inserting promotional content into an immersive virtual reality world may provide significant advantages to users experiencing the immersive virtual reality world, virtual reality content providers presenting the immersive virtual reality world, and sponsors associated with the promotional content. For example, users may benefit by receiving access to quality virtual reality media content for which costs are covered or offset by sponsors, while avoiding traditional advertising methods that may detract unnecessarily from the immersiveness of the virtual reality experience.

Virtual reality content providers may benefit by being able to insert promotional content into sponsored virtual reality media content to offset costs of the virtual reality media content while effectively holding users' attention in the immersive virtual reality world by avoiding the traditional advertising methods likely to detract from the immersiveness of the virtual reality experience. Moreover, by accessing and inserting 2D promotional content that is already available from commercial advertising exchange services (e.g., for use in traditional advertising methods), virtual reality content providers may have access to a much wider selection of potential sponsors and promotional content than if the providers were limited to sponsors and promotional content specifically adapted only for use with virtual reality media content.

Similarly, sponsors (e.g., commercial advertisers) generating and paying to have promotional content inserted into immersive virtual reality worlds may benefit by gaining promotional access to effectively promote their products and services to users of virtual reality media content without having to shoulder costs of generating new promotional content specifically adapted only for use with virtual reality media content.

Various embodiments will now be described in more detail with reference to the figures. The disclosed methods and systems may provide one or more of the benefits mentioned above and/or various additional and/or alternative benefits that will be made apparent herein.

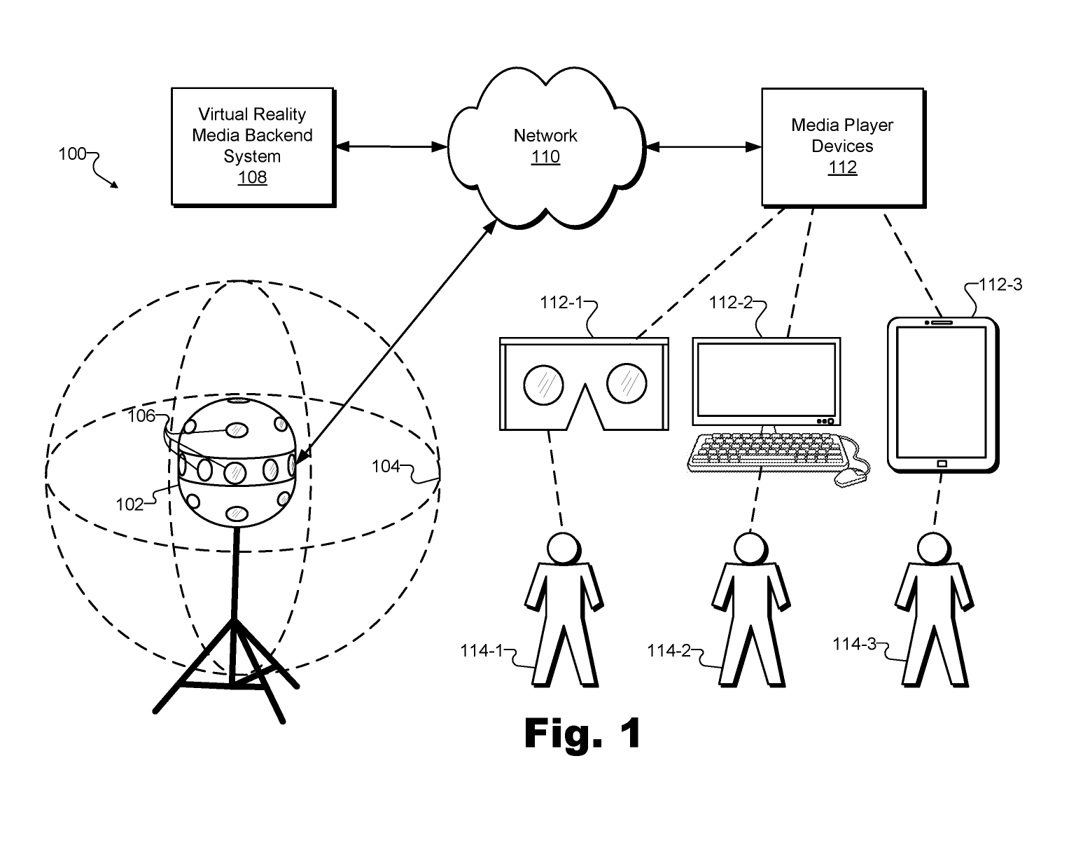

FIG. 1 illustrates an exemplary configuration 100 in which exemplary embodiments of a 360-degree camera, a virtual reality media backend system, and one or more media player devices operate to insert promotional content into an immersive virtual reality world. As shown in FIG. 1, a 360-degree camera 102 (“camera 102”) may capture and/or generate a 360-degree image of real-world scenery 104 around a center point corresponding to camera 102. For example, camera 102 may capture a plurality of images from each of a plurality of segment capture cameras 106 built into or otherwise associated with camera 102, and may generate the 360-degree image of real-world scenery 104 by combining the plurality of images captured by segment-capture cameras 106.

Camera 102 may capture data representative of 360-degree images of real-world scenery 104 and transmit the data to a virtual reality media backend system 108 (“backend system 108”) by way of a network 110. After preparing and/or processing the data representative of the 360-degree images to generate an immersive virtual reality world based on the 360-degree images, backend system 108 may transmit data representative of the immersive virtual reality world to one or more media player devices 112 such as a head-mounted virtual reality device 112-1, a personal computer device 112-2, a mobile device 112-3, and/or to any other form factor of media player device that may serve a particular implementation. Regardless of what form factor media player devices 112 take, users 114 (e.g., users 114-1 through 114-3) may experience the immersive virtual reality world by way of media player devices 112. Each of the elements of configuration 100 will now be described in detail.

Camera 102 may be set up and/or operated by a virtual reality content creator and may include any type of camera that is configured to capture data representative of a 360-degree image of real-world scenery 104 around a center point corresponding to camera 102. As used herein, a 360-degree image is any still or video image that depicts the surroundings (e.g., real-world scenery 104) of a center point (e.g., a center point associated with the location of camera 102) on all sides along at least one dimension. For example, one type of 360-degree image may include a panoramic image that depicts a complete 360-degree by 45-degree ring around a center point corresponding to a camera (e.g., camera 102). Another type of 360-degree image may include a spherical image that depicts not only the ring around the center point, but an entire 360-degree by 180-degree sphere surrounding the center point on all sides. In certain examples, a 360-degree image may be based on a non-circular geometric structure. For example, certain 360-degree images may be based on cubes, rectangular prisms, pyramids, and/or other geometric structures that may serve a particular implementation, rather than being based on spheres.

Camera 102 may be configured to capture the data representative of the 360-degree image of real-world scenery 104 in any way that may serve a particular implementation. For example, as shown in FIG. 1, camera 102 may capture various segments of real-world scenery 104 using segment capture cameras 106, which may each capture an image of a single segment of real-world scenery 104 that may be combined (e.g., stitched together) with other segments to generate the 360-degree image of real-world scenery 104. In certain examples, segment capture cameras 106 may each represent a single camera unit (e.g., including a lens and suitable image capture hardware) built into a single 360-degree camera configured to capture 360-degree images. In other examples, camera 102 may include an array of segment capture cameras 106 that are each a single, standalone camera configured to capture standard images (e.g., images depicting less than a 360-degree view) that may later be combined to form the 360-degree image. In yet other examples, camera 102 may include one or more “fish-eye” lenses configured to capture a very wide-angle image (e.g., a spherical image or a semi-spherical image) that can be used as the 360-degree image or processed to generate the 360-degree image. Alternatively, camera 102 may include a single, standard camera that captures and/or combines a plurality of still images of real-world scenery 104 taken at different points in time (e.g., using a “panorama mode” of the camera or a similar feature) to capture still 360-degree images. In certain examples, camera 102 may include one or more cameras for a stereoscopic effect. Camera 102 may also use any combination of the 360-degree image capture techniques described above or any other capture techniques that may serve a particular implementation.

Subsequent to capturing raw image data representative of real-world scenery 104, camera 102 may generate from the raw image data a 360-degree image of real-world scenery 104. For example, camera 102 may be configured to automatically process the raw image data (e.g., by combining a plurality of images captured by segment capture cameras 106, by processing images captured by a fish-eye lens, etc.) to form the 360-degree image, and then may transmit data representative of the 360-degree image to backend system 108. Alternatively, camera 102 may be configured to transmit the raw image data directly to backend system 108, and any processing and/or combining of the raw image data may be performed within backend system 108.

Camera 102 may capture any real-world scenery 104 that may serve a particular embodiment. For example, real-world scenery 104 may include any indoor or outdoor real-world location such as the streets of a city, a museum, a scenic landscape, a satellite orbiting and looking down upon the Earth, the surface of another planet, or the like. Real-world scenery 104 may further include certain events such as a stock car race, a football game or other sporting event, a large-scale party such as New Year's Eve on Times Square in New York City, or other events that may interest potential users. In certain examples, real-world scenery 104 may be a setting for a fictionalized event, such as a set of a live-action virtual reality television show or movie.

In some implementations, capturing real-world scenery 104 using camera 102 may be optional. For example, a 360-degree image of scenery surrounding a center point may be completely computer-generated (e.g., animated) based on models of an imaginary world rather than captured from real-world scenery 104 by camera 102. As such, camera 102 may be omitted in certain examples.

Backend system 108 may be associated with (e.g., provided and/or managed by) a virtual reality media content service provider (e.g., a network service provider, a cable service provider, a satellite service provider, an Internet service provider, a provider of virtual reality mobile applications, etc.) and may be configured to provide virtual reality media content to users (e.g., subscribers of a virtual reality media content service, users who download or otherwise acquire virtual reality mobile applications) by way of media player devices 112. To this end, backend system 108 may receive, generate, process, and/or maintain data representative of virtual reality media content. For example, backend system 108 may be configured to receive camera-captured data (e.g., video data captured by camera 102) representative of a 360-degree image of real-world scenery 104 around a center point corresponding to camera 102. If the camera-captured data is raw image data (e.g., image data captured by each of segment capture cameras 106 that has not been combined into a 360-image), backend system 108 may unwrap, combine (i.e., stitch together), or otherwise process the raw image data to form the 360-degree image representative of real-world scenery 104.

Based on the camera-captured data representative of real-world scenery 104 (e.g., the 360-degree image), backend system 108 may generate and maintain an immersive virtual reality world (i.e., data representative of an immersive virtual reality world that may be experienced by a user). For example, backend system 108 may generate a three-dimensional (“3D”) model of the immersive virtual reality world where virtual objects may be presented along with projections of real-world scenery 104 to a user experiencing the immersive virtual reality world. To generate the immersive virtual reality world, backend system 108 may perform video transcoding, slicing, orchestration, modeling, and/or any other processing that may serve a particular embodiment.

Subsequent to or concurrent with generating one or more immersive virtual reality worlds associated with one or more virtual reality media content instances (also referred to herein as “virtual reality media content programs”), backend system 108 may provide access to the virtual reality media content programs for users such as subscribers of a virtual reality media content service operated by the virtual reality media content provider and/or users who download or otherwise acquire virtual reality mobile applications provided by the virtual reality media content provider. To this end, backend system 108 may present a field of view of the immersive virtual reality world to users by way of media player devices 112 in response to requests from media player devices 112 to access the virtual reality media content. For example, as will be described in more detail below, backend system 108 may present the field of view by transmitting data representative of content of the immersive virtual reality world (e.g., virtual objects within the immersive virtual reality world, images of real-world scenery 104, etc.) to media player devices 112, which may render the data to display the content on their screens. Examples of immersive virtual reality worlds, fields of view of immersive virtual reality worlds, and virtual objects presented along with projections of real-world scenery 104 within immersive virtual reality worlds will be described below.

Camera 102, backend system 108, and media player devices 112 may communicate with one another using any suitable communication technologies, devices, media, and/or protocols supportive of data communications, including, but not limited to, socket connections, Ethernet, data bus technologies, data transmission media, communication devices, Transmission Control Protocol (“TCP”), Internet Protocol (“IP”), File Transfer Protocol (“FTP”), Telnet, Hypertext Transfer Protocol (“HTTP”), HTTPS, Session Initiation Protocol (“SIP”), Simple Object Access Protocol (“SOAP”), Extensible Mark-up Language (“XML”) and variations thereof, Real-Time Transport Protocol (“RTP”), User Datagram Protocol (“UDP”), Global System for Mobile Communications (“GSM”) technologies, Code Division Multiple Access (“CDMA”) technologies, Evolution Data Optimized Protocol (“EVDO”), 4G Long Term Evolution (“LTE”), Voice over IP (“VoIP”), Voice over LTE (“VoLTE”), WiMax, Time Division Multiple Access (“TDMA”) technologies, Short Message Service (“SMS”), Multimedia Message Service (“MMS”), radio frequency (“RF”) signaling technologies, wireless communication technologies (e.g., Bluetooth, Wi-Fi, etc.), in-band and out-of-band signaling technologies, and other suitable communications technologies.

Network 110 may include any provider-specific network (e.g., a cable or satellite carrier network or a mobile telephone network), the Internet, wide area network, or any other suitable network. Data may flow between camera 102, backend system 108, and media player devices 112 by way of network 110 using any communication technologies, devices, media, and protocols as may serve a particular implementation. While only one network 110 is shown to interconnect camera 102, backend system 108, and media player devices 112 in FIG. 1, it will be recognized that these devices and systems may intercommunicate by way of multiple interconnected networks as may serve a particular implementation.

Media player devices 112 (i.e., head-mounted virtual reality device 112-1, personal computer device 112-2, and mobile device 112-3) may be used by users 114 (i.e., users 114-1 through 114-3) to access and experience virtual reality media content received from backend system 108. To this end, media player devices 112 may each include or be implemented by any device capable of presenting a field of view of an immersive virtual reality world and detecting user input from a user (e.g. one of users 114) to dynamically change the content within the field of view as the user experiences the immersive virtual reality world. For example, media player devices 112 may include or be implemented by a head-mounted virtual reality device (e.g., a virtual reality gaming device), a personal computer device (e.g., a desktop computer, laptop computer, etc.), a mobile or wireless device (e.g., a smartphone, a tablet device, a mobile reader, etc.), or any other device or configuration of devices that may serve a particular implementation to facilitate receiving and/or presenting virtual reality media content. As will be described in more detail below, different types of media player devices 112 (e.g., head-mounted virtual reality devices, personal computer devices, mobile devices, etc.) may provide different types of virtual reality experiences having different levels of immersiveness for users 114.

Media player devices 112 may be configured to allow users 114 to select respective virtual reality media content programs that users 114 may wish to experience on their respective media player devices 112. In certain examples, media player devices 112 may download virtual reality media content programs that users 114 may experience offline (e.g., without an active connection to backend system 108). In other examples, media player devices 112 may request and receive data streams representative of virtual reality media content programs that users 114 experience while media player devices 112 remain in active communication with backend system 108 by way of network 110.

To facilitate users 114 in experiencing virtual reality media content, each of media player devices 112 may include or be associated with at least one display screen upon which a field of view of an immersive virtual reality world may be presented. Media player devices 112 may also include software configured to receive, maintain, and/or process data representative of the immersive virtual reality world to present content of the immersive virtual reality world within the field of view on the display screens of the media player devices. For example, media player devices 112 may include dedicated, standalone software applications (e.g., mobile applications) configured to process and present data representative of immersive virtual reality worlds on the displays. In other examples, the software used to present the content of the immersive virtual reality worlds may include non-dedicated software such as standard web browser applications.

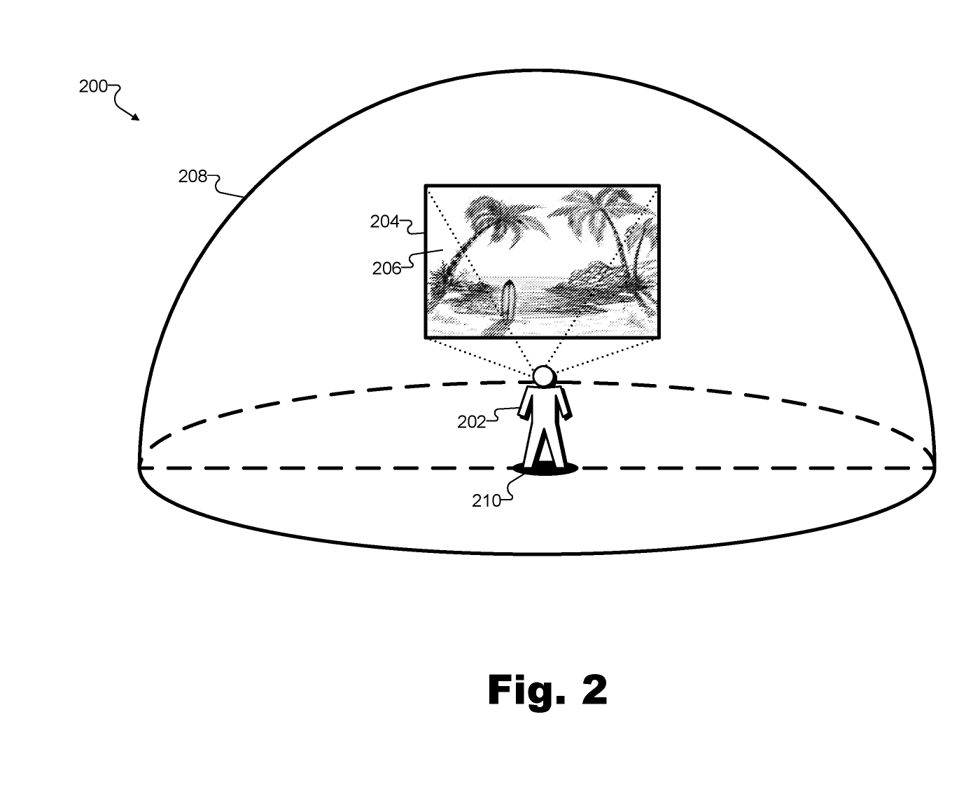

FIG. 2 illustrates an exemplary virtual reality experience 200 in which a user 202 is presented with an exemplary field of view 204 that includes content 206 of an exemplary immersive virtual reality world 208. User 202 may experience immersive virtual reality world 208 (“world 208”) by providing user input to dynamically change field of view 204 to display whatever content within world 208 that user 202 wishes to view. For example, the user input provided by user 202 may include an indication that user 202 wishes to look at content not currently presented within field of view 204 (i.e., content of world 208 other than content 206). For media player devices 112 such as personal computer 112-2 and/or mobile device 112-3, this user input may include a mouse movement, navigation key input from a keyboard, a swipe gesture, or the like. For media player devices 112 incorporating particular sensors (e.g., motion, directional, and/or orientation sensors) such as head-mounted virtual reality device 112-1 and/or mobile device 112-3, however, this user input may include a change to an orientation of the display screen of the media player device 112 with respect to at least one axis of at least two orthogonal axes. For example, the media player device may be configured to sense changes in orientation of the display screen with respect to an x-axis, a y-axis, and a z-axis that are all orthogonal to one another. As such, the media player device 112 may be configured to detect the change to the orientation of the display screen as user 202 experiences world 208, and the dynamic changing of the content includes gradually replacing content 206 with other content of world 208 that is determined to be visible from a viewpoint of user 202 within world 208 according to the detected change to the orientation of the display screen with respect to the at least one axis.

To illustrate, FIG. 2 shows that content 206 may include real-world scenery depicting a beach with palm trees and a surfboard. User 202 may provide user input to a media player device by which user 202 is experiencing world 208 (e.g., one of media player devices 112) to indicate that user 202 wishes to look at content to the left of content 206 currently included within field of view 204. For example, user 202 may press a left navigation key on a keyboard, perform a swipe gesture to the right, or change the orientation of the display screen with respect to a y-axis by rotating his or her head to the left while wearing a head-mounted device. In response, the real-world scenery (i.e., the palm trees, the surfboard, etc.) may scroll to the right across field of view 204 to give user 202 a sensation that he or she is turning to look to the left in world 208. As content 206 scrolls off the right side of field of view 204, new content (not explicitly shown in FIG. 2) smoothly scrolls onto the left side of field of view 204. In this way, user 202 may provide user input to cause field of view 204 to present any part of world 208 that user 202 desires.

In FIG. 2, world 208 is illustrated as a semi-sphere, indicating that user 202 may look in any direction that is substantially forward, backward, left, right, and/or up. However, if user 202 directs field of view 204 down, world 208 may not include dynamic and/or real-world scenery content to be presented within field of view 204. For example, if world 208 includes a dynamic immersive virtual reality world (i.e., using a 360-degree video image), field of view 204 may present a still image representative of the ground of world 208. In other examples, field of view 204 may present nothing (i.e., a black screen), a menu, one or more virtual objects, or any other suitable image that may serve a particular implementation. In other examples, world 208 may include an entire 360-degree by 180-degree sphere so that every direction in which user 202 may direct field of view 204 is associated with dynamic and/or real-world scenery content of world 208.

As shown in FIG. 2, world 208 may appear to surround a center point 210 associated with user 202. In some embodiments, center point 210 may be correspond to a location of a camera (e.g., camera 102) used to capture the content of world 208 (e.g., including content 206). As such, center point 210 may be static or may move through world 208 in a way that user 202 is unable to control (e.g. moving through world 208 in a same manner as camera 102 moved through real-world scenery 104 during the creation of the virtual reality media content). In other embodiments, user 202 may be able to provide input to modify where center point 210 is located within world 208. For example, user 202 may hop from one center point to another (e.g., corresponding to where each of a plurality of 360-degree cameras captured 360-degree images) within world 208 or cause center point 210 to move continuously within world 208. While center point 210 is illustrated at the feet of user 202 for simplicity of illustration, it will be understood that center point 210 may actually be located at the eye level of user 202.

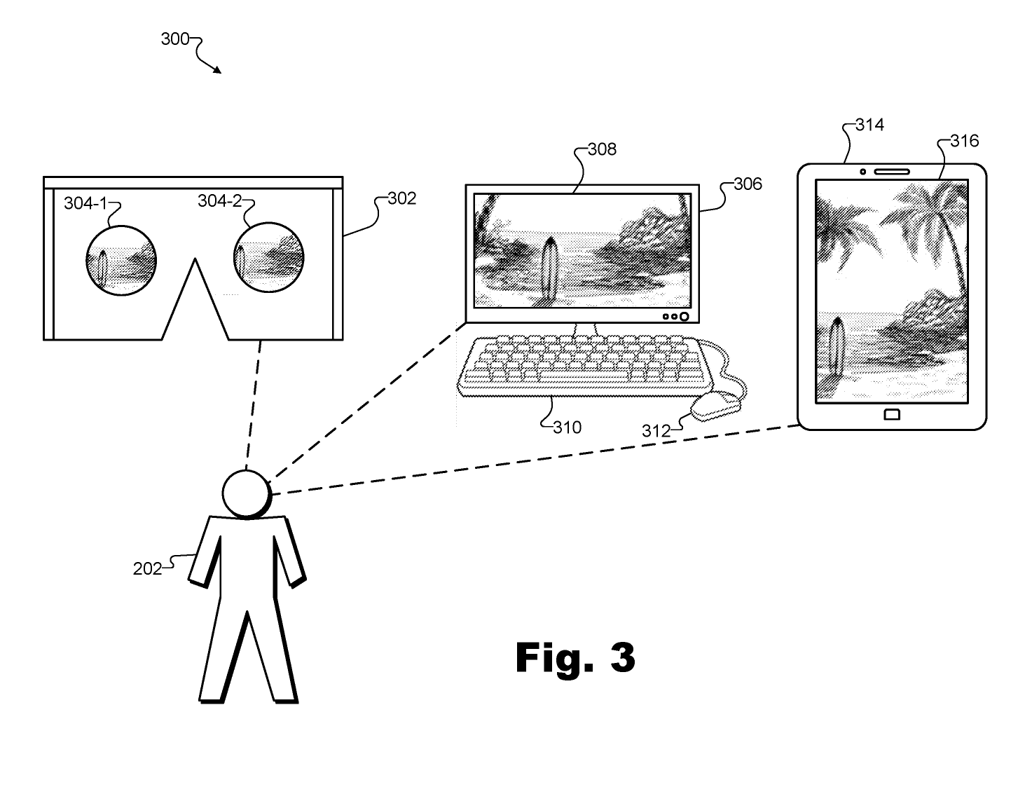

As mentioned above, different types of media player devices may provide different experiences for user 202 by presenting field of view 204 of world 208 in different ways, by receiving user input from user 202 in different ways, and so forth. To illustrate, FIG. 3 shows exemplary media player devices 300 configured to facilitate experiencing of world 208 by user 202. Media player devices 300 may correspond to media player devices 112, described above in relation to FIG. 1.

As one example, a head-mounted virtual reality device 302 may be mounted on the head of user 202 and arranged so that each of the eyes of user 202 sees a distinct display screen 304 (e.g., display screens 304-1 and 304-2) within head-mounted virtual reality device 302. In some examples, a single display screen 304 may be presented and shared by both eyes of user 202. In other examples, as shown, distinct display screens 304 within head-mounted virtual reality device 302 may be configured to display slightly different versions of field of view 204 (e.g., stereoscopic versions of field of view 204 that may be captured by one or more cameras) to give user 202 the sense that world 208 is three-dimensional. Display screens 304 may also be configured to display content 206 such that content 206 fills the peripheral vision of user 202, providing even more of a sense of realism to user 202. Moreover, head-mounted virtual reality device 302 may include motion sensors (e.g., accelerometers), directional sensors (e.g., magnetometers), orientation sensors (e.g., gyroscopes), and/or other suitable sensors to detect natural movements (e.g., head movements) of user 202 as user 202 experiences world 208. Thus, user 202 may provide input indicative of a desire to move field of view 204 in a certain direction and by a certain amount in world 208 by simply turning his or her head in that direction and by that amount. As such, head-mounted virtual reality device 302 may provide user 202 with a natural and hands-free experience that does not require any physical console control to experience the immersive virtual reality world and that may be the most immersive virtual reality experience provided by any type of media player device.

As another example of a media player device, a personal computer device 306 having a display screen 308 (e.g., a monitor) may be used by user 202 to experience world 208. Because display screen 308 may not provide the distinct stereoscopic view for each of the user's eyes and/or may not fill the user's peripheral vision, personal computer device 306 may not provide the same degree of immersiveness that head-mounted virtual reality device 302 provides. However, personal computer device 306 may be associated with other advantages such as its ubiquity among casual virtual reality users that may not be inclined to purchase or use a head-mounted virtual reality device. In some examples, personal computer device 306 may allow a user to experience virtual reality content within a standard web browser so that user 202 may conveniently experience world 208 without using special devices or downloading special software. User 202 may provide user input to personal computer device 306 by way of a keyboard 310 (e.g., using navigation keys on keyboard 310 to move field of view 204) and/or by way of a mouse 312 (e.g., by moving mouse 312 to move field of view 204). In certain examples, a combination of keyboard 310 and mouse 312 may be used to provide user input such as by moving field of view 204 by way of navigation keys on keyboard 310 and clicking or otherwise interacting with objects within world 208 by way of mouse 312.

As yet another example of a media player device, a mobile device 314 having a display screen 316 may be used by user 202 to experience world 208. Mobile device 314 may incorporate certain advantages of both head-mounted virtual reality devices and personal computer devices to provide the most versatile type of media player device for experiencing world 208. Specifically, like personal computer devices, mobile devices are extremely ubiquitous, potentially providing access to many more people than dedicated head-mounted virtual reality devices. However, because many mobile devices are equipped with motion sensors, directional sensors, orientation sensors, etc., mobile devices may also be configured to provide user 202 with an immersive experience comparable to that provided by head-mounted virtual reality devices. For example, mobile device 314 may be configured to divide display screen 316 into two versions (e.g., stereoscopic versions) of field of view 204 and to present content 206 to fill the peripheral vision of user 202 when mobile device 314 is mounted to the head of user 202 using a relatively inexpensive and commercially-available mounting apparatus (e.g., a cardboard apparatus). In other embodiments, mobile device 314 may facilitate experiencing world 208 by receiving movement-based user input at arm's length (i.e., not mounted to the head of user 202 but acting as a hand-held dynamic window for looking around world 208), by receiving swipe gestures on a touchscreen, or by other techniques that may serve a particular embodiment.

While examples of certain media player devices have been described, the examples are illustrative and not limiting. A media player device may include any suitable device and/or configuration of devices configured to facilitate receipt and presentation of virtual reality media content according to principles described herein. For example, a media player device may include a tethered device configuration (e.g., a tethered headset device) or an untethered device configuration (e.g., a display screen untethered from a processing device). As another example, a head-mounted virtual reality media player device or other media player device may be used in conjunction with a virtual reality controller such as a wearable controller (e.g., a ring controller) and/or a handheld controller.

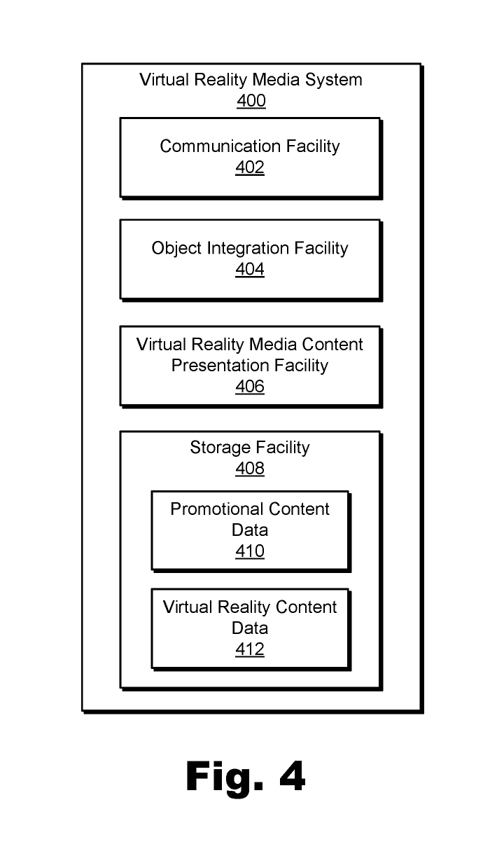

FIG. 4 illustrates an exemplary virtual reality media system 400 (“system 400”) configured to insert promotional content into an immersive virtual reality world. As shown, system 400 may include, without limitation, a communication facility 402, an object integration facility 404, a virtual reality media content presentation facility 406, and a storage facility 408 selectively and communicatively coupled to one another. It will be recognized that although facilities 402-408 are shown to be separate facilities in FIG. 4, any of facilities 402-408 may be combined into fewer facilities, such as into a single facility, or divided into more facilities as may serve a particular implementation.

System 400 may be implemented by or may include one or more devices and/or systems of configuration 100, described above in relation to FIG. 1. For example, system 400 may be implemented entirely by backend system 108, entirely by one of media player devices 112, or by any combination of backend system 108 and a media player device 112 that may serve a particular implementation. In certain embodiments, camera 102, components of network 110, and/or one or more other computing devices (e.g., servers) remote from and communicatively coupled to media player devices 112 by way of network 110 may also serve to implement at least certain components and/or operations of system 400. As will be described in more detail below, system 400 may be used to present field of view 204 of world 208 (described above in relation to FIG. 2) within a display screen of a media player device (e.g., any of the media player devices described herein).

Storage facility 408 may maintain promotional content data 410 and/or virtual reality content data 412 generated, received, transmitted, and/or used by communication facility 402, object integration facility 404, and/or virtual reality media content presentation facility 406. For example, promotional content data 410 may include data representative of promotional content that is not specifically adapted for being experienced within an immersive virtual reality world, such as 2D promotional content accessed from a commercial advertising exchange service. Examples of 2D promotional content will be described in more detail below. Promotional content data 410 may further include data representative of promotional content that is specifically adapted for being experienced within an immersive virtual reality world. For example, promotional content data 410 may include content of an immersive virtual reality world separate from world 208 that may be presented to and experienced by user 202 before, after, or during a promotional break in the middle of a virtual reality media content program. Promotional content data 410 may also include any other data that may serve a particular implementation.

Similarly, virtual reality content data 412 may include data representative of content of world 208 (e.g., data representative of one or more 360-degree images that include content 206 shown in FIG. 2), data representative of one or more virtual objects that may be presented within world 208 (e.g., 3D virtual objects having an outer surface that is designated as a promotional content platform), data representative of promotional content platforms associated with virtual objects, data representative of display parameters assigned to virtual objects, and/or data used to facilitate mapping a 2D promotional image (e.g., a 2D promotional image stored in promotional content data 410) onto a promotional content platform on the outer surface of a 3D virtual object such that the 2D promotional image is viewable as a skin of the 3D virtual object when the outer surface of the 3D virtual object is located within field of view 204 of world 208. Virtual reality content data 412 may further include data representative of an area of world 208 currently being presented within field of view 204, data used to track the location of field of view 204, data used to track the gaze of user 202 (i.e., where user 202 is looking within field of view 204), data used to render content to be presented within field of view 204, and/or any other data that may serve a particular implementation.

Communication facility 402 may perform any suitable communication operations for proper functionality of system 400. For example, as will be described in more detail below, communication facility 402 may access promotional content (e.g., by requesting and receiving the promotional content) from a source of promotional content such as a commercial advertisement exchange service. Moreover, communication facility 402 may receive or transmit data representative of world 208 and virtual objects integrated into world 208 to facilitate virtual reality media content presentation facility 406 in providing field of view 204 for display on the display screen of one of media player devices 112.

For example, in an embodiment where system 400 is entirely implemented by backend system 108, communication facility 402 may facilitate providing field of view 204 for display on the display screen by transmitting data representative of field of view 204 and/or virtual objects integrated into world 208 to one of media player devices 112. Conversely, in an implementation where system 400 is entirely implemented by a media player device (e.g., one of media player devices 112 or 300), communication facility 402 may facilitate providing field of view 204 for display on the display screen by receiving data representative of content of world 208 and/or the integrated virtual objects within world 208 from backend system 108.

Object integration facility 404 may perform any suitable operations for integrating virtual objects into world 208. For example, as will be described in more detail below, object integration facility 404 may integrate a 3D virtual object having an outer surface designated as a promotional content platform into world 208. To this end, object integration facility 404 may facilitate generating world 208 based on data representative of a 360-degree image (e.g., of camera-captured real-world scenery 104) by assigning virtual objects display parameters (e.g., positional parameters, orientational parameters, scaling parameters, time parameters, etc.) to determine how and when the virtual objects are to be presented within world 208. Examples of display parameters and portions of the outer surface of virtual objects that may be designated as promotional content platforms will be described below.

Virtual reality media content presentation facility 406 may perform any suitable image presentation and/or rendering operations for proper functionality of system 400. For example, as will be described in more detail below, virtual reality media content presentation facility 406 may provide field of view 204 of world 208 for display on a display screen of one of media player devices 300 (e.g., display screens 304 of head-mounted virtual reality device 302, display screen 308 of personal computer device 306, or display screen 316 of mobile device 314). In providing field of view 204 for display, virtual reality media content presentation facility 406 may continuously and dynamically change (i.e., re-render and update) content presented within field of view 204 (e.g., including content 206) in response to user input provided by user 202 while user 202 experiences world 208. Additionally, virtual reality media content presentation facility 406 may present virtual objects within field of view 204 that have been integrated into world 208 (e.g., by object integration facility 404). Examples of fields of view of immersive virtual reality worlds will be described below, including examples in which content is presented that includes virtual objects with promotional content mapped to promotional content platforms on the outer surfaces of the virtual objects.

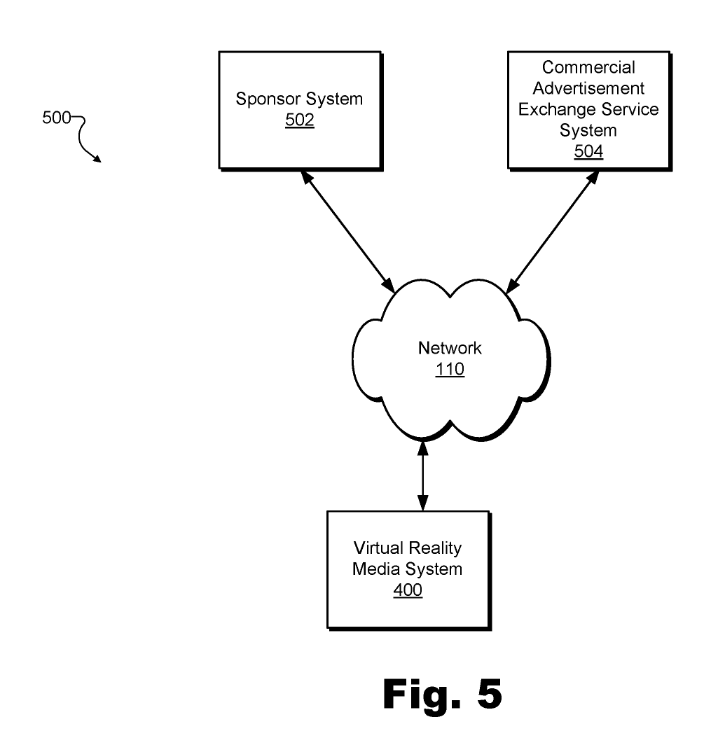

FIG. 5 illustrates an exemplary configuration 500 where system 400 is in communication with other systems and/or devices to insert promotional content into an immersive virtual reality world. In particular, configuration 500 shows system 400 along with a sponsor system 502 and a commercial advertisement exchange service system 504 communicatively coupled to one another and to system 400 via network 110. As described above, system 400 may be implemented entirely by backend system 108, entirely by one or more of media player devices 112, or by a combination of backend system 108, media player devices 112, and/or other suitable computing devices as may serve a particular implementation.

Either or both of sponsor system 502 and commercial advertisement exchange service system 504 may be used by system 400 in accessing data representative of a promotional image that system 400 inserts into an immersive virtual reality world such as world 208. For example, in certain implementations, sponsor system 502 may include a computing system associated with a sponsor (e.g., a commercial sponsor such as a company promoting goods and/or services, a nonprofit sponsor promoting a charitable cause, a public interest sponsor promoting political ideas and/or a particular candidate for a political office, etc.) that is providing support (e.g., monetary or commercial support) for world 208 and/or a virtual reality media content program with which world 208 is associated. In return for providing the support, the sponsor associated with sponsor system 502 may use world 208 and/or the virtual reality media content program associated with world 208 as a platform for promoting products or services that the sponsor offers. For example, the sponsor may provide promotional content (e.g., commercial advertising material) that can be presented to users before, after, or while the users experience world 208. In certain examples, the sponsor may provide promotional content that includes virtual reality content configured to be presented within or along with world 208, or promotional content that includes a separate immersive virtual reality world that may be presented to user 202 in place of world 208 before world 208 is presented (e.g., as a pre-roll ad), after world 208 is presented (e.g., as a post-roll ad), and/or during a commercial break while world 208 is being presented (e.g., as a mid-roll ad). In other examples, the sponsor may directly provide 2D promotional content that includes a commercial advertisement associated with the sponsor (e.g., a still or animated banner ad, a television-style commercial spot, etc.).

Commercial advertisement exchange service system 504 may be operated by a third party (e.g., a party that is neither the virtual reality media content provider associated with system 400 nor the sponsor associated with sponsor system 502) to facilitate the pairing of sponsors wishing to promote particular content with media content providers that control platforms on which promotional campaigns can be effectively implemented (e.g., media content viewed by large numbers of people). For example, well-known companies like GOOGLE, YAHOO, AOL, and others may operate commercial advertisement exchange services to facilitate distribution of advertisements for integration with web content on the Internet. In some examples, commercial advertisement exchange services may be largely or exclusively configured to distribute traditional, 2D promotional material. For example, commercial advertisements exchange services may provide commercial advertisements configured to be displayed as banner ads, pop-up ads, television-style commercial spots (e.g., to be played in association with on-demand video content), and/or other types of 2D promotional material commonly presented with web content.

Because well-established commercial advertisement exchange services may have a larger selection and/or offer more convenient aggregated access to potential paid advertising than may be possible from single individual sponsors, it may be particularly advantageous for system 400 to access promotional content from such services. As such, one advantage of the disclosed systems and methods is that a wide array of available 2D promotional content may be inserted into and experienced within world 208 in a way that maximizes the immersion of user 202 in world 208 without limiting the selection of promotional content to only the relatively small amount of promotional content specifically configured for use with immersive virtual reality media content. Accordingly, system 400 may access data representative of a 2D promotional image (e.g., a commercial advertisement) by requesting and accessing the 2D promotional image from commercial advertisement exchange service system 504 in addition or as an alternative to requesting 2D and/or virtual reality promotional images directly from sponsor system 502.

In certain examples, the requesting of a 2D promotional image such as a commercial advertisement may be based on a characteristic of the user (e.g., user 202) and/or of the camera-captured real-world scenery of the immersive virtual reality world (e.g., world 208). For example, system 400 may maintain (e.g., within storage facility 408) profile data associated with user 202. For instance, system 400 may maintain demographic information for user 202 such as an age of user 202, a gender of user 202, a race of user 202, etc. Additionally or alternatively, system 400 may maintain data related to personal interests of user 202 (e.g., based on previous purchases of user 202) or other suitable data that may be used to request promotional content that will be relevant, effective, and/or of interest to user 202. Similarly, system 400 may request the 2D promotional image based on characteristics of world 208. For example, if world 208 is associated with a sporting event, system 400 may request 2D promotional images related to the sporting event (e.g., a youth football camp) or related to products that people may be likely to consume while experiencing the sporting event (e.g., soft drinks, snack foods, etc.). In other examples, system 400 may request a 2D promotional image from sponsor system 502, commercial advertisement exchange service system 504, and/or any other suitable source based on any characteristic or criterion that may serve a particular embodiment.

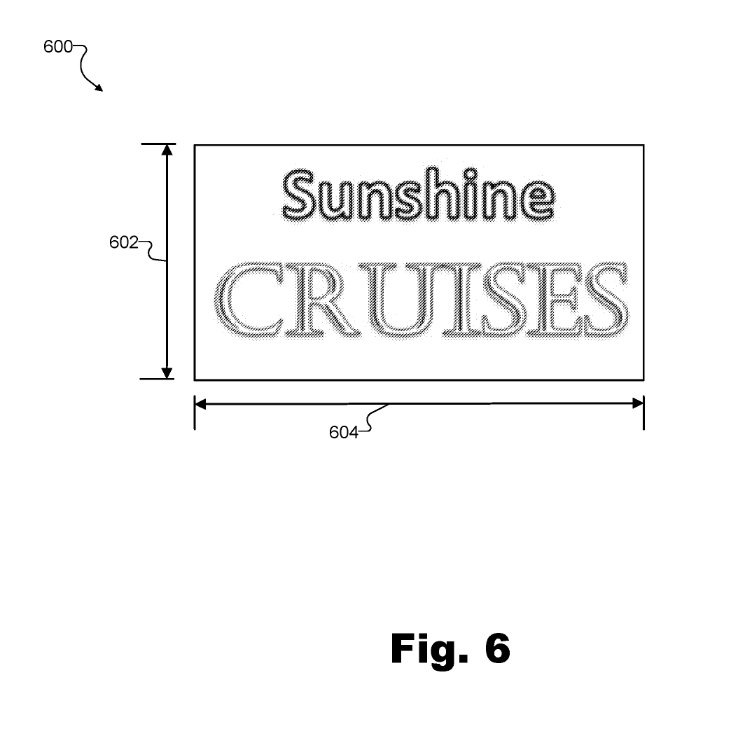

FIG. 6 illustrates an exemplary 2D promotional image 600 (“image 600”) that may be accessed and inserted into world 208 according to principles described herein. Image 600 may be representative of any type of 2D promotional image including any still image, animated image, or video content associated with promotional efforts of any type of sponsor, whether commercial or noncommercial. For example, image 600 may be requested and/or accessed from a commercial advertisement exchange service (e.g., by way of commercial advertisement exchange service system 504) based on one or more characteristics of user 202 and/or world 208, as described above. In some examples, image 600 may be a banner advertisement (e.g., a still image or animated image that includes purely visual content). In other examples, image 600 may include a video presentation (e.g., a video such as a television-style commercial spot) that includes audio and visual content.

In the same or other examples, image 600 may be interactive such that image 600 may present a banner advertisement under normal circumstances but may begin a video presentation under special circumstances such as when system 400 detects that the attention of user 202 (e.g. a gaze of user 202) is directed at image 600. Similarly, image 600 may be interactive such that user 202 may interact with image 600 to get more information about a product, service, or other promotional objective associated with image 600. For example, system 400 may present additional information associated with the promotional objective of image 600 such as a location where a product associated with image 600 can be purchased, a phone number whereby a service associated with image 600 may be obtained, or a website whereby any promotional objective associated with image 600 can be researched or accessed. In certain examples, system 400 may convert the platform upon which image 600 is presented (e.g., a promotional content platform of a virtual object within world 208) into a simplified or full web browser by which a user 202 may actively research and/or purchase items or services associated with the promotional objective of image 600 without leaving world 208.

In the example shown in FIG. 6, image 600 includes a commercial advertisement for a commercial cruise line called “Sunshine Cruises.” As such, image 600 may include a logo identifying the cruise line and any pictorial or animated graphics that may serve a particular implementation to further facilitate promotion of the cruise line. An embedded video presentation or link to a website for Sunshine Cruises may additionally be embedded within data representative of image 600 to be activated by system 400 when particular circumstances arise (e.g., user 202 selects image 600 or is detected to have directed his or her attention to image 600). As described above in relation to FIG. 5, system 400 may access the commercial advertisement for Sunshine Cruises of image 600 by directly receiving data representative of image 600 from sponsor system 502, which may be, in this example, a server system associated with the Sunshine Cruises cruise line company. Additionally or alternatively, system 400 may request, from third-party commercial advertisement exchange service system 504, a commercial advertisement associated with cruising or vacations or the like based on maintained profile data indicating that user 202 has purchased cruises in the past, a detection that world 208 is a tropical world similar to destinations to which Sunshine Cruises sails, etc. In response, commercial advertisement exchange service system 504 may provide image 600, which the Sunshine Cruises cruise line agrees to pay to promote within world 208.

As shown in FIG. 6, image 600 may have particular 2D dimensions such as a height 602 associated with a vertical dimension of the image and a width 604 associated with a horizontal dimension of the image. As such, image 600 may be associated with a specific aspect ratio defined as the ratio of width 604 to height 602. For example, image 600 may have an aspect ratio of a wide, narrow rectangle if width 604 is much larger than height 602, or image 600 may be a square if width 604 is equal to height 602. In certain implementations, system 400 may request a 2D promotional image having specific 2D dimensions (e.g., height 602 and/or width 604) and/or a specific aspect ratio to fit a particular promotional content platform (e.g., a promotional content platform on the outer surface of a particular virtual object) within world 208 that is available for a promotional content. In the same or other implementations, system 400 may receive a 2D promotional image having specific 2D dimensions (e.g., height 602 and/or width 604) and/or a specific aspect ratio and may generate a virtual object and/or a promotional content platform on the surface of a virtual object to cater specifically to the specific 2D dimensions or aspect ratio received.

As explained above, system 400 may access data representative of image 600 in order to map image 600 onto a promotional content platform on the outer surface of a 3D virtual object integrated into an immersive virtual reality world. Based on the mapping of image 600 onto the promotional content platform of the integrated 3D virtual object, image 600 may be viewable as a skin of the 3D virtual object when the 3D virtual object is located within a field of view of the immersive virtual reality world.

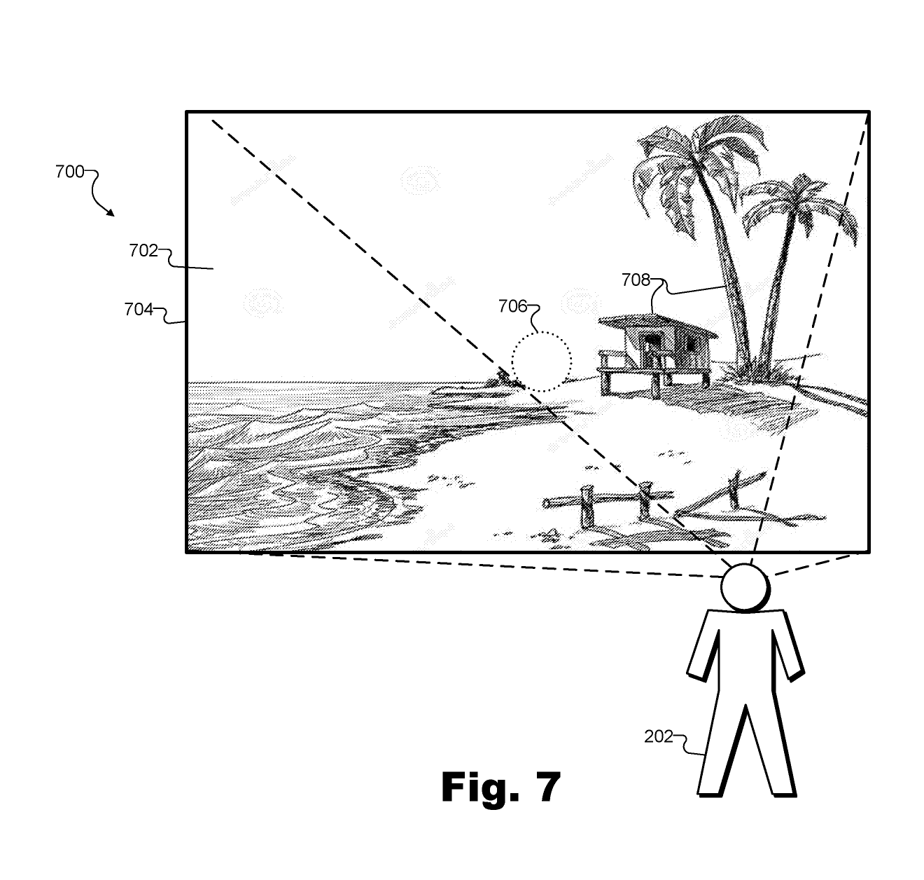

To illustrate, FIG. 7 shows an exemplary field of view of an immersive virtual reality world that includes a generic virtual object integrated into the immersive virtual reality world. More particularly, user 202 is shown to be experiencing an immersive virtual reality world 700 (“world 700”) that includes content 702 being presented within a field of view 704. As shown, world 700 may include content based on camera-captured real-world scenery depicting a tropical beach scene. In the example of FIG. 7, user 202 may have entered user input to dynamically direct field of view 704 to include content showing a perspective looking down the beach that includes a generic virtual object 706 and real objects 708 (i.e., camera-captured objects such as a beach shack and palm trees that were present in the real-world scenery rather than integrated into world 700 later).

Virtual object 706 may represent any virtual object that may serve a particular implementation. In particular, virtual object 706 may represent a 3D virtual object including an outer surface at least a portion of which may be designated as a promotional content platform for displaying promotional content such as image 600.

As will be illustrated and described in more detail below, a first type of 3D virtual object that may be integrated into world 700 may be referred to as a “billboard” virtual object and may be used primarily as a platform for inserting promotional content (e.g., image 600) into world 700. To this end, a billboard virtual object may have an outer surface designated as the promotional content platform that includes the entire (or nearly the entire) outer surface of the billboard virtual object. As used herein, billboard virtual objects may include a width dimension and/or a height dimension, but may have little or no depth dimension. In other words, billboard virtual objects may appear within world 700 to be very thin or even to be two-dimensional. However, as used herein, billboard virtual objects may still be considered to be 3D virtual objects when they are inserted (e.g., according to one or more 3D display parameters as will be described below) into world 700. For example, as opposed to a 2D banner advertisement that is shown at the bottom of a screen and always looks the same regardless of where user 202 directs field of view 704, a billboard virtual object integrated within world 700 may be viewed within field of view 704 from different angles and/or from different distances within world 700 to give user 202 different perspectives on the billboard virtual object based on how user 202 directs field of view 704.

In certain examples, billboard virtual objects may be configured to stand alone in the immersive virtual reality world. As such, billboard virtual objects may be formed from simple shapes (e.g., rectangles, squares, circles, triangles, etc.) and may include a planar surface (i.e., a flat surface) that may be designated as the promotional content platform. In other examples, billboard virtual objects may be configured to integrate with other virtual objects or camera-captured real objects in the immersive virtual reality world. In these cases, billboard virtual objects may take the shape and form of the real or virtual objects the billboard virtual objects are integrated with. For example, a billboard virtual object could be integrated with an image of a hot air balloon in the camera-captured real-world scene, the billboard virtual object being shaped and formed to look as if the billboard virtual object were wrapped around all or a portion of the outer surface of the hot air balloon.

A second type of 3D virtual object that may be integrated into world 700 may be referred to as a “context-specific” virtual object and may add value to world 700 beyond the promotional objective that the promotional content platform of the virtual object may serve. For example, context-specific objects may be complex objects that are similar to real objects 708 within world 700 and/or are otherwise selected to fit within the context of world 700. In the context of the beach scene of world 700, for example, context-specific virtual objects may include virtual objects that may typically be seen in the sky (i.e., planes, parasailers, etc.), in the water (i.e., boats, animal life, etc.), or on the sand (i.e., sand castles, beach vendors, etc.) in a beach scene.

In many examples, context-specific virtual objects may include width, height, and depth dimensions, and may include outer surfaces having more complex shapes and curves than the planar surfaces of the basic-shaped billboard virtual objects. Accordingly, context-specific virtual objects may have outer surfaces designated as promotional content platforms that include only a portion of the entire outer surface of the virtual objects, rather than the entire (or nearly the entire) outer surface, as with the billboard virtual objects described above. As such, a designated promotional content platform of a context-specific virtual object may include a curved area, and the mapping of a 2D promotional image (e.g., image 600) onto the promotional content platform on the outer surface of the context-specific virtual object may comprise graphically distorting at least a portion of the 2D promotional image that is mapped to the curved area of the promotional content platform. Examples of both billboard and context-specific virtual objects having outer surfaces designated as promotional content platforms will be illustrated and described in more detail below.

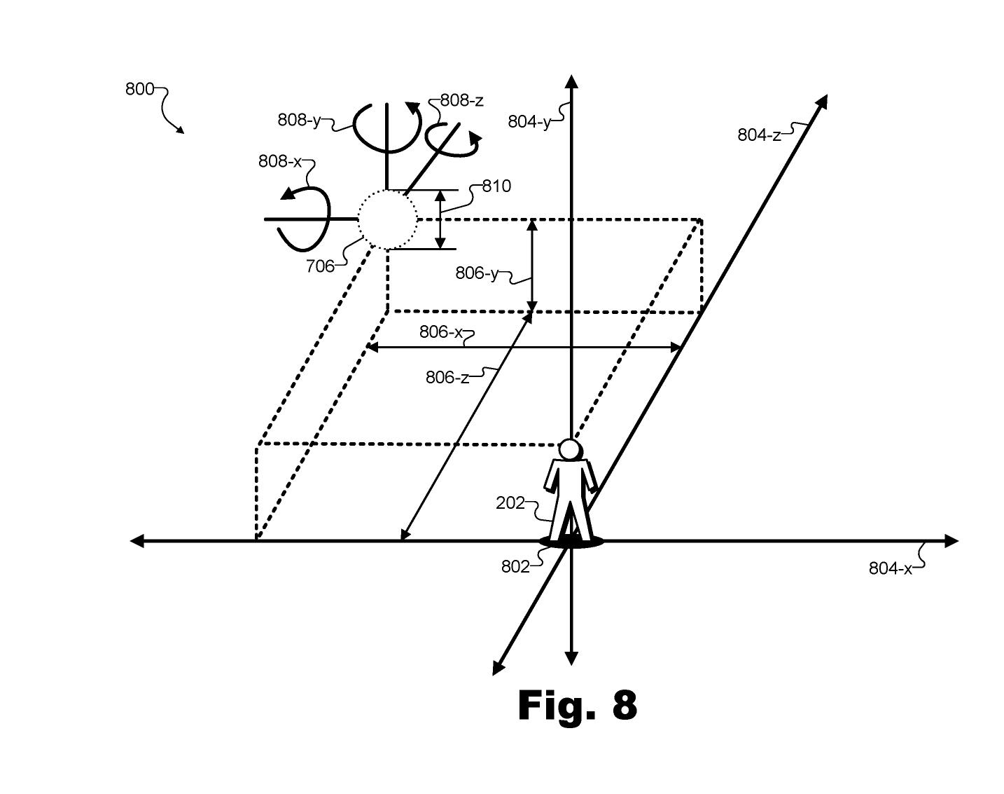

Regardless of the type of virtual object that virtual object 706 implements, system 400 may integrate virtual object 706 into world 700 by assigning virtual object 706 a plurality of display parameters that may be used to determine an appearance of virtual object 706 to user 202 as user 202 experiences world 700 through field of view 704. To illustrate, FIG. 8 shows exemplary display parameters assigned to virtual object 706 to integrate virtual object 706 into world 700.

Specifically, FIG. 8 illustrates a model view 800 of world 700 including a renderable model of virtual object 706 within a renderable model of world 700. As used herein, a “renderable model” is a digital or mathematical representation of an object (e.g., a virtual object such as virtual object 706, an immersive virtual reality world such as world 700, etc.) that, when properly rendered for display, may be presented (or presented in part) on a display screen such as on one of the display screens of one of media player devices 300 described above in reference to FIG. 3. Thus, while FIG. 7 shows a rendered view of world 700 as world 700 may be presented to user 202 within field of view 704, model view 800 illustrates how certain elements of world 700 (e.g., virtual object 706) may be modeled in the data representative of world 700 that system 400 may provide for display on the display screen.

Moreover, while a renderable model of virtual object 706 may persistently exist in a renderable model of world 700, virtual object 706 may or may not be rendered and/or presented on the display screen of the media player device 300 used by user 202. For example, if user 202 provides user input to direct field of view 704 toward content of world 700 that does not include virtual object 706 (e.g., content behind user 202 with respect to the direction user 202 is facing in FIG. 7), the renderable model of virtual object 706 may continue to exist in the renderable model of world 700, even while object 706 may not be rendered and/or presented within field of view 704 to be seen by user 202. Accordingly, while model view 800 of world 700 may be helpful for describing and illustrating the insertion of virtual objects such as virtual object 706 into world 700, it will be understood that model view 800 merely represents a visual conceptualization of a particular embodiment of data representative of world 700, and that model view 800 may not actually be rendered or presented to user 202 as such.

As shown in FIG. 8, model view 800 includes an origin 802 corresponding to a coordinate system including three axes 804 (i.e., x-axis 804-x, y-axis 804-y, and z-axis 804-z) that may each cross through origin 802 at orthogonal angles. Origin 802 may correspond to center point 210, described above in relation to FIG. 2, in that a renderable model of world 700 may be maintained in relation to a center point corresponding to a camera used to capture a 360-degree image upon which world 700 is based (e.g., camera 102 of FIG. 1). As described above in relation to center point 210, while user 202 is shown slightly above origin 802, it will be understood that, in some implementations, origin 802 may actually be located at an eye level of user 202 rather than at the feet of user 202.

To integrate virtual object 706 into world 700, system 400 may assign virtual object 706 one or more display parameters used to determine an appearance of virtual object 706 to user 202 as user 202 experiences world 700 through field of view 704 as may serve a particular implementation. For example, as shown, virtual object 706 may be assigned one or more positional parameters 806 determinative of a location of virtual object 706 within world 700 (i.e., positional parameter 806-x determinative of the location of virtual object 706 with respect to x-axis 804-x, positional parameter 806-y determinative of the location of virtual object 706 with respect to y-axis 804-y, and positional parameter 806-z determinative of the location of virtual object 706 with respect to z-axis 804-z).

Virtual object 706 may further be assigned one or more orientational parameters 808 determinative of a rotational orientation of virtual object 706 within world 700 (i.e., orientational parameter 808-x determinative of the orientation of virtual object 706 with respect to x-axis 804-x, orientational parameter 806-y determinative of the orientation of virtual object 706 with respect to y-axis 804-y, and orientational parameter 806-z determinative of the orientation of virtual object 706 with respect to z-axis 804-z).

Virtual object 706 may also be assigned one or more scaling parameters determinative of an apparent size of virtual object 706 within world 700, as illustrated by scaling parameter 810. In the implementation of FIG. 8, a single scaling parameter 810 is illustrated to show that virtual object 706 may be configured to scale proportionally along each orthogonal dimension such that virtual object 706 maintains a constant form rather than allowing one dimension of virtual object 706 to scale disproportionately from another dimension. However, it is noted that a plurality of scaling parameters 810 (e.g., separate scaling parameters to scale virtual object 706 independently with respect to each of axes 804) may be used in certain implementations.

Additionally, virtual object 706 may be assigned a time parameter determinative of a time period during which virtual object 706 is viewable within world 700. While a time parameter is not explicitly illustrated in FIG. 8, it will be understood that world 700 may change dynamically as time passes such that certain virtual objects that are presented at one time may not necessarily be presented at a later time. For example, if world 700 is associated with a virtual reality media content program (e.g., a virtual reality movie or a virtual reality television show), a scene represented within world 700 during a first time period of the virtual reality media content program may include virtual object 706, while a scene represented within world 700 during a second time period later in the program may no longer include virtual object 706.

In some examples, at least one of the display parameters assigned to virtual object 706 (e.g., positional parameters 806, orientational parameters 808, and/or scale parameter 810) may dynamically change as time in world 700 passes and user 202 experiences world 700. As such, virtual object 706 may appear to user 202 to move or change within world 700. For example, if one or more positional parameters 806 assigned to virtual object 706 dynamically change as user 202 experiences world 700, the location of virtual object 706 within world 700 (e.g., in relation to other content of world 700) may appear to change over time. Specifically, virtual object 706 may appear to approach user 202, recede from user 202, move across world 700, or otherwise change locations within world 700. Similarly, if one or more orientational parameters 808 assigned to virtual object 706 dynamically change as user 202 experiences world 700, the rotational orientation of virtual object 706 within world 700 (e.g., in relation to other content of world 700) may appear to change over time. For example, virtual object 706 may appear to gradually rotate such that virtual object 706 may be viewed from multiple perspectives, virtual object 706 may appear to spin or otherwise rotate in response to user input or events occurring in world 700, etc. Additionally, if scale parameter 810 assigned to virtual object 706 dynamically changes as user 202 experiences world 700, the apparent size of virtual object 706 within world 700 (e.g., in relation to other content of world 700) may appear to change over time. For example, virtual object 706 may appear to grow or shrink based on user input and/or events occurring within world 700.

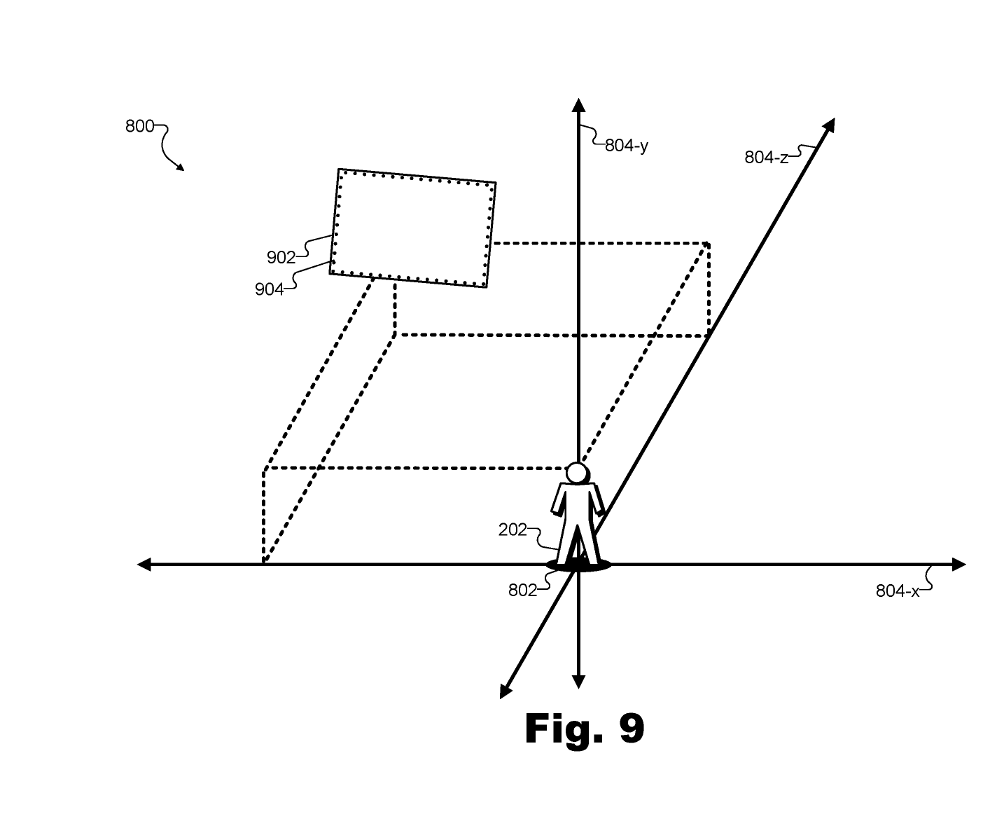

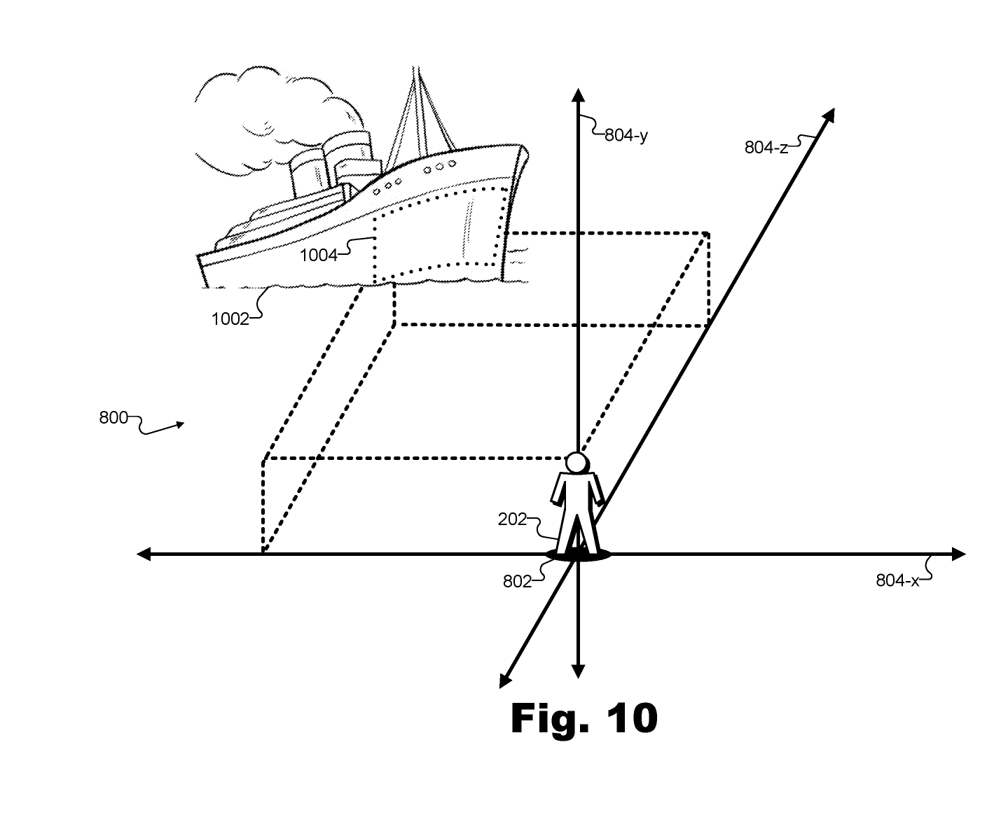

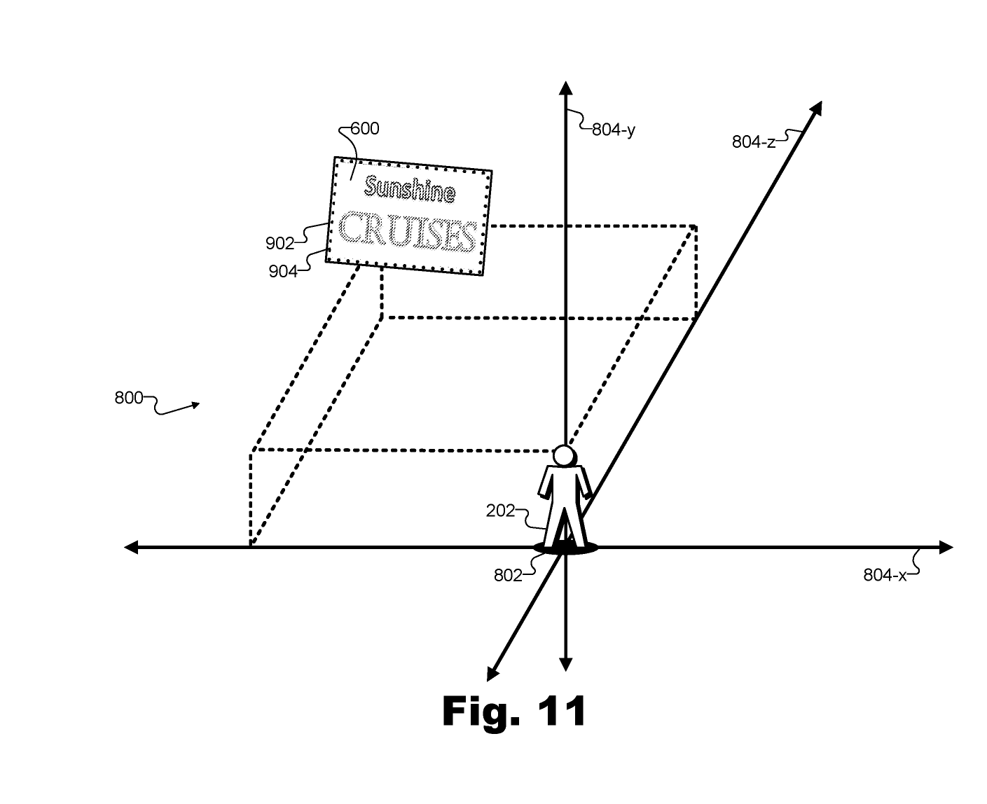

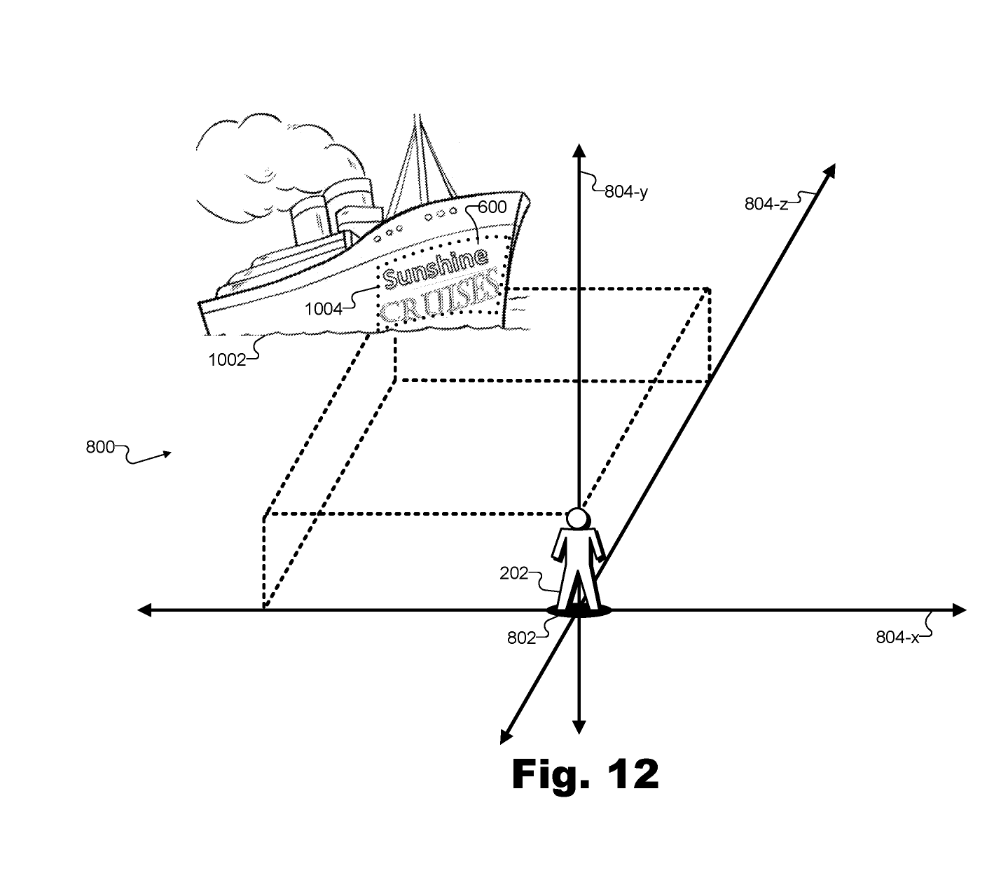

Specific examples illustrating how system 400 may integrate different types of 3D virtual objects (e.g., billboard virtual objects, context-specific objects, etc.) into an immersive virtual reality world by assigning the 3D virtual objects display parameters used to determine the appearance of the 3D virtual object to a user as the user experiences the immersive virtual reality world through the field of view will now be described. In particular, FIGS. 9-10 illustrate model views of exemplary 3D virtual objects having exemplary promotional content platforms that system 400 may integrate into world 700, and FIGS. 11-12 illustrate model views of exemplary mappings of image 600 (i.e., the 2D promotional image described above in relation to FIG. 6) onto the 3D virtual objects such that image 600 is viewable as a skin of the 3D virtual objects when the outer surface of the 3D virtual objects is located within field of view 704 of world 700.

FIG. 9 shows model view 800 of world 700 in which generic virtual object 706 is replaced by a billboard virtual object 902. As shown, because billboard virtual object 902 may be configured primarily to facilitate the insertion of promotional content into world 700 (i.e., without adding any other significant value to world 700), the entire outer surface of billboard virtual object 902 or nearly the entire outer surface of billboard virtual object 902 (e.g., the entire outer surface other than a narrow border around an outer edge) may be a planar surface designated as a promotional content platform 904. As further shown in FIG. 9, while billboard virtual object 902 may have little or no depth, billboard virtual object 902 may still be manipulated as a 3D virtual object within world 700 according to x, y, and z dimensions of each display parameter.

For example, as shown, billboard virtual object 902 may be positioned at a particular location in world 700 offset from origin 802 on each of x-axis 804-x, y-axis 804-y, and z-axis 804-z. Moreover, billboard virtual object 902 may be oriented in a particular way with respect to origin 802 and axes 804. Specifically, as shown, the planar surface designated as promotional content platform 904 may be essentially parallel with a plane including x-axis 804-x and y-axis 804-y so that promotional content displayed on promotional content platform 904 can be easily viewed by user 202 at origin 802. However, as further shown in FIG. 9, the orientation parameter of billboard virtual object 902 with respect to z-axis 804-x (i.e., orientational parameter 806-z described above in relation to FIG. 8) may include a slight rotation in a clockwise direction to facilitate billboard virtual object 902 in fitting into the context of world 700, as will be illustrated below. Additionally, billboard virtual object 902 may be presented as the particular size shown in FIG. 9 based on a scaling parameter such as scaling parameter 810 described above in relation to FIG. 8.

Similarly, FIG. 10 shows model view 800 of world 700 in which generic virtual object 706 is replaced by a context-specific virtual object 1002. As shown, based on a characteristic of user 202 and/or world 700 (e.g., a determination by system 400 that user 202 has a potential interest in cruises, the fact that world 700 is a tropical beach commonly experienced by people on cruises, etc.) context-specific virtual object 1002 may be a large cruise ship that may add value to world 700 (i.e., by accenting the tropical theme of world 700) beyond a mere promotional objective such as that of billboard virtual object 902. As such, and in contrast to billboard virtual object 902, only a portion of the entire outer surface of context-specific virtual object 1002 (e.g., a broad forward section of the hull of the cruise ship) may be designated as a promotional content platform 1004. Additionally, because context-specific virtual object 1002 is a more complex type of object than billboard virtual object 902, promotional content platform 1004 may include a curved area rather than a simple planar surface. Specifically, as shown, promotional content platform 1004 curves in three-dimensional space from a wide area of the hull at mid ship to a point at the front of the ship.

Like billboard virtual object 902, context-specific virtual object 1002 may be manipulated as a 3D virtual object within world 700 according to x, y, and z dimensions of each display parameter. For example, as shown, context-specific virtual object 1002 may be positioned at a particular location in world 700 offset from origin 802 on each of x-axis 804-x, y-axis 804-y, and z-axis 804-z. Moreover, context-specific virtual object 1002 may be oriented in a particular way with respect to origin 802 and axes 804. Specifically, as shown, the orientation of the ship along the x and z dimensions make the ship appear to be upright in the water (i.e., the bottom of the ship is essentially parallel with the ocean surface along the plane including x-axis 804-x and z-axis 804-z). However, as further shown in FIG. 9, the orientation parameter of context-specific virtual object 1002 with respect to y-axis 804-y (i.e., orientational parameter 806-y described above in relation to FIG. 8) may be assigned such that the portion of the outer surface of the hull designated as promotional content platform 1004 is generally facing the plane including x-axis 804-x and y-axis 804-y to facilitate easy viewing of promotional content displayed on promotional content platform 1004 by user 202 at origin 802. Additionally, context-specific virtual object 1002 may be presented as the particular size shown in FIG. 10 based on a scaling parameter such as scaling parameter 810 described above in relation to FIG. 8.

FIG. 11 illustrates an exemplary mapping of image 600 (described above in relation to FIG. 6) onto promotional content platform 904 on the outer surface of billboard virtual object 902 in model view 800 of world 700. As shown in FIG. 11, image 600 may be mapped (e.g., texture mapped or otherwise projected) onto promotional content platform 904 such that image 600 is viewable as a skin of billboard virtual object 902 when billboard virtual object 902 is located within field of view 704 of world 700, as will be illustrated below. Mapping image 600 onto the outer surface of promotional content platform 904 may include mapping the flat, 2D promotional content of image 600 onto the planar surface of promotional content platform 904.

FIG. 12 illustrates an exemplary mapping of image 600 onto promotional content platform 1004 on the outer surface of context-specific virtual object 1002 in model view 800 of world 700. As shown in FIG. 12, image 600 may be mapped (e.g., texture mapped or otherwise projected) onto promotional content platform 1004 such that image 600 is viewable as a skin of context-specific virtual object 1002 when context-specific virtual object 1002 is located within field of view 704 of world 700, as will be illustrated below. However, unlike the situation where the flat, 2D promotional content of image 600 was mapped onto the planar surface of promotional content platform 904 as described above in relation to FIG. 11, mapping image 600 onto promotional content platform 1004 of context-specific virtual object 1002 may include graphically distorting at least a portion of image 600 that is mapped to the curved area of promotional content platform 1004. Specifically, as shown, image 600 may be graphically distorted (i.e., the letters of the “Sunshine Cruises” logo appearing to slightly ascend toward the right-hand side of image 600) from the perspective of user 202 to give a sense that image 600 is actually painted or otherwise projected onto the side of the ship as a “skin” of the ship.

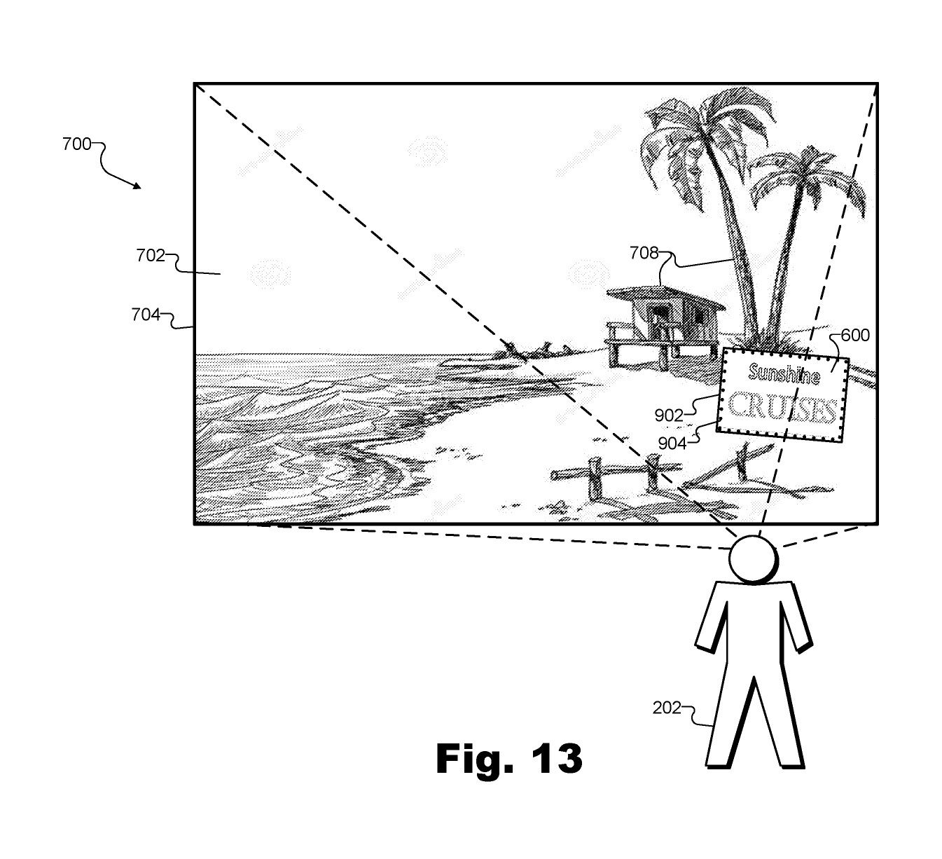

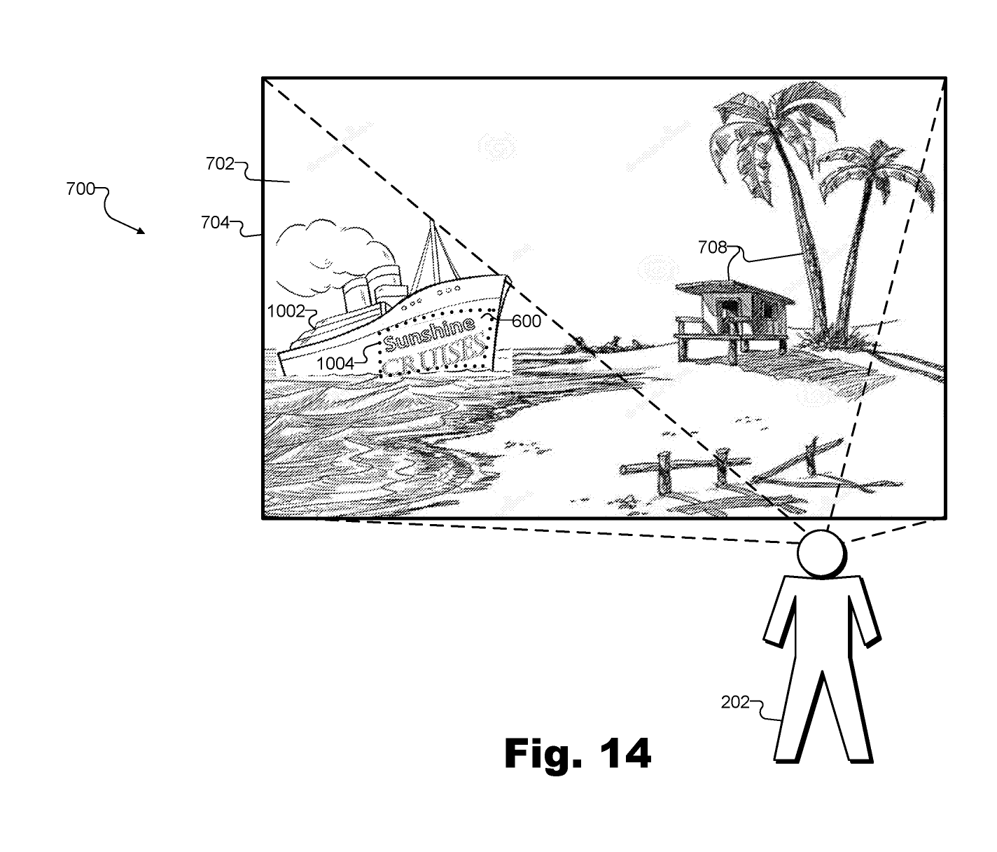

As described above, system 400 may generate a field of view of an immersive virtual reality world including content that includes a portion of a 360-degree image (e.g., of camera-captured real-world scenery including one or more real objects) together with one or more 3D virtual objects integrated into the immersive virtual reality world. As further described above, integrating the 3D virtual objects into the immersive virtual reality world may include assigning display parameters to the 3D virtual objects to determine the appearance of the 3D virtual objects within the field of view to a user experiencing the immersive virtual reality world by way of the field of view. Additionally, 2D promotional images may be mapped onto promotional content platforms of the 3D virtual objects to be viewable as skins of the 3D virtual objects to the user presented with the field of view. FIGS. 13 and 14 illustrate the convergence of these concepts with respect to a billboard virtual object and to a context-specific virtual object, respectively.

Specifically, FIGS. 13-14 illustrate a field of view 704 of world 700 including either billboard virtual object 902 (in the case of FIG. 13) or context-specific virtual object 1002 (in the case of FIG. 14) integrated into world 700 with image 600 viewable as a skin of the respective virtual objects 902 and 1002.

In FIG. 13, billboard virtual object 902 includes promotional content platform 904, onto which image 600 is mapped to be viewable as a skin of billboard virtual object 902. Billboard virtual object 902 is presented within world 700 at a location within world 700 determined by positional parameters, as described above. As further described above, billboard virtual object 902 is oriented with a slight clockwise tilt to make it appear to be resting on the beach (e.g., to follow contours of the ground it appears to be resting on). Similarly, in FIG. 14, context-specific virtual object 1002 includes promotional content platform 1004, onto which image 600 is mapped to be viewable as a skin of context-specific virtual object 1002. Context-specific virtual object 1002 is presented within world 700 at a different location within world 700 than billboard virtual object 1002, as determined by its own set of positional parameters. While each of virtual objects 902 and 1002 are illustrated alone in separate examples of field of view 704 of world 700, in certain examples, both virtual objects 902 and 1002 may be presented within world 700 together at the same time, possibly including different 2D promotional images so that user 202 does not see image 600 on two different virtual objects.

As described above, image 600 may include video content that is configured to be presented to user 202 only under special circumstances. In other words, image 600, as presented within either promotional content platform 904 (in FIG. 13) or 1004 (in FIG. 14) may appear to be a still image such as the illustrated “Sunshine Cruises” logo until an event such as user input or an event within world 700 triggers image 600 to present a video presentation. More specifically, system 400 may detect, subsequent to the mapping of image 600 onto at least one of the respective promotional content platforms 904 and 1004, that the promotional content platform 904 or 1004 is located within field of view 704. In response to this detection that the promotional content platform 904 and/or 1004 is located within field of view 704, system 400 may play back the video content included within image 600 for viewing by user 202 on the respective promotional content platform 904 or 1004 that is located within field of view 704. Moreover, image 600 may further include audio content associated with the video content. Thus, in response to the detection that the promotional content platform 904 and/or 1004 is located within field of view 704, system 400 may play back, along with the video content, the audio content associated with the video content.

In certain examples, when a video presentation is presented to user 202 within world 700, system 400 may facilitate the viewing of the video presentation by user 202 by directing the attention of user 202 to the video presentation. For example, as part of playing back the video content for viewing by user 202, system 400 may dim a portion of content 702 of world 700 included within field of view 704 during the playback of the video content. In other examples, system 400 may center and/or enlarge the video presentation within field of view 704, freeze field of view 704, mute audio from world 700 other than audio associated with the video presentation, or perform any other suitable operation to facilitate user 202 in viewing the video presentation.

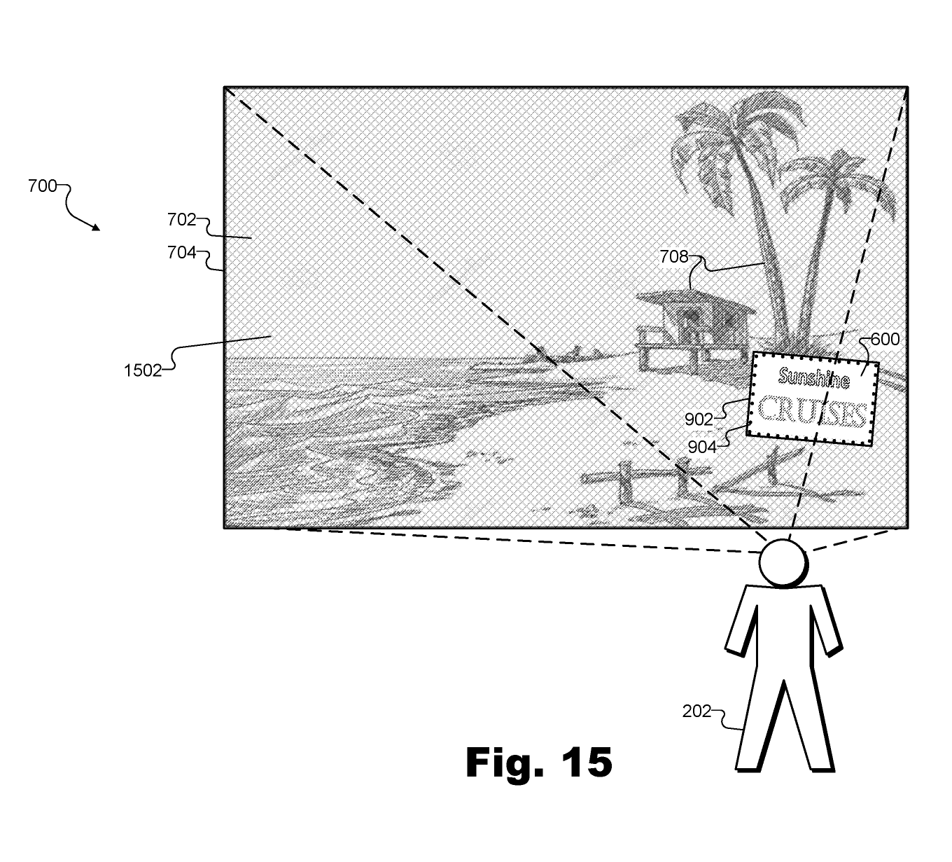

To illustrate, FIG. 15 shows field of view 704 of world 700 where a portion of content 702 of world 700 is dimmed to facilitate viewing promotional content by user 202. Specifically, as shown, the dimmed portion of content 702 includes at least some content within field of view 704 other than the video content (i.e., image 600) being played back on promotional content platform 904. In certain examples, a larger or smaller portion of content 702 may be dimmed out as may serve a particular implementation.

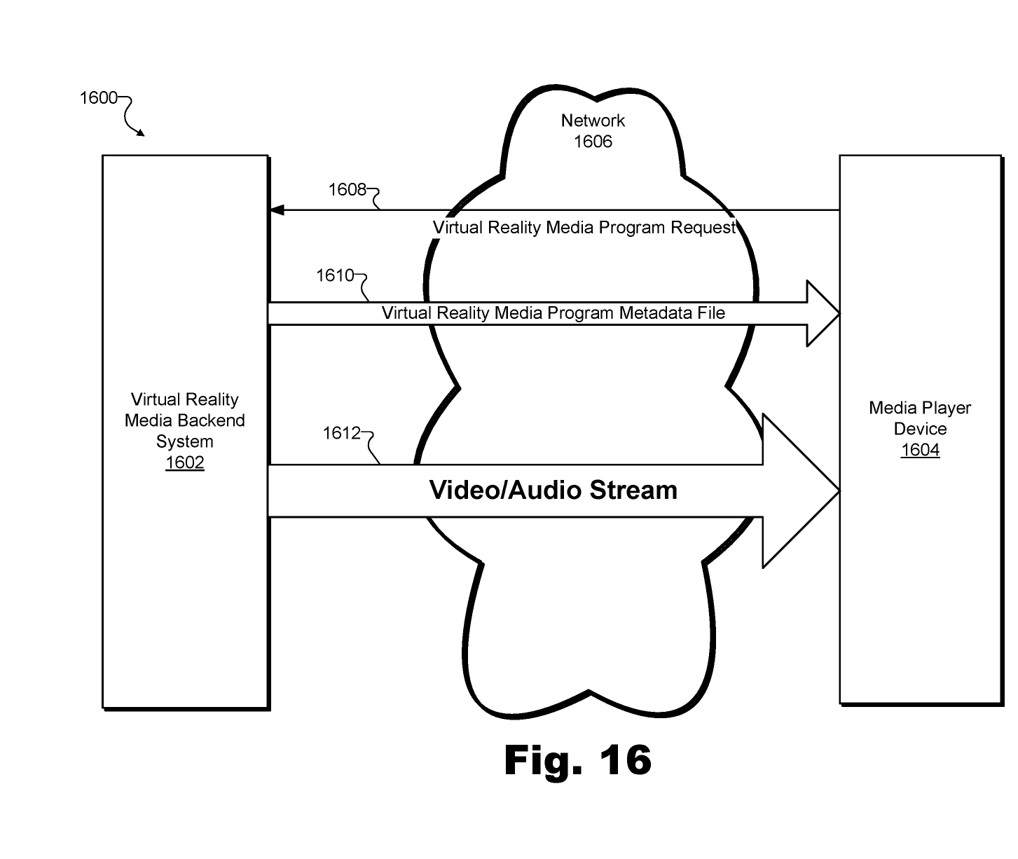

FIG. 16 illustrates an exemplary configuration 1600 in which an exemplary virtual reality media backend system 1602 (“backend system 1602”) and an exemplary media player device 1604 operate to insert promotional content into an immersive virtual reality world. Backend system 1602 and media player device 1604 may be the same or similar to other systems and/or devices described herein, and, as such, may each be implemented by an end-user device, by a server device that streams media content to an end-user device, or distributed across an end-user device and a server device. For example, backend system 1602 may be the same or similar to backend system 108, and media player device 1604 may be the same or similar to any of media player devices 112 or 300. Additionally, backend system 1602 and/or media player device 1604 may implement, individually or together in combination, some or all of the functionality of system 400 described above.

As shown, backend system 1602 and media player device 1604 may be communicatively coupled via a network 1606, which may use various network components and protocols to facilitate communication between backend system 1602 and media player device 1604 in the same or a similar fashion as described above in relation to network 110. In particular, as will be described below, network 1606 may carry data representative of a virtual reality media program request 1608 (“request 1608”), a virtual reality media program metadata file 1610 (“metadata file 1610”), a video/audio stream 1612, and any other data that may be transferred between backend system 1602 and media player device 1604.

As illustrated by configuration 1600, in operation, media player device 1604 may transmit request 1608 to backend system 1602 over network 1606. For example, media player device 1604 may transmit request 1608 (e.g., a Hypertext Transfer Protocol (“HTTP”) call) based on user input from a user of media player device 1604. Specifically, media player device 1604 may provide the user one or more options to request access to virtual reality media content such as by providing a selection of links (e.g., HTTP links) to a variety of virtual reality media content (e.g., different immersive virtual reality worlds). In response to user input to access the virtual reality media content of a particular immersive virtual reality world (e.g., a user selection of a particular link from the selection of links), media player device 1604 may transmit request 1608 to backend system 1602. Request 1608 may include a command (e.g., associated with an HTTP call) that causes backend system 1602 to transmit data representative of metadata file 1610 and/or video/audio stream 1612 to media player device 1604 by way of network 1606.

As one example, request 1608 may include a command that causes backend system 1602 to transmit data representative of metadata file 1610 to media player device 1604, and metadata file 1610 may include data representative of one or more additional commands that cause media player device 1604 to perform other operations including requesting, receiving, and/or presenting video/audio stream 1612. For instance, prior to presenting the immersive virtual reality world for the user to experience, additional commands in metadata file 1610 may cause media player device 1604 to request (e.g., from sponsor system 502 or commercial advertisement exchange service system 504 of FIG. 5), receive, and/or present a promotional, pre-roll video to the user based upon keywords and/or tags included in metadata file 1610. After the promotional video has been presented, metadata file 1610 may include additional commands to cause media player device 1604 to request, receive, and/or present a virtual reality media program based on video/audio stream 1612 and other data within metadata file 1610, as described below. Additionally or alternatively, metadata file 1610 may include additional commands to cause media player device 1604 to request, receive, and/or present one or more mid-roll promotional videos during the presentation of the virtual reality media program (e.g., during a commercial break), or one or more post-roll promotional videos after the presentation of the virtual reality media program.

As another example, metadata file 1610 may include metadata related to one or more virtual objects (e.g., display parameters for the virtual objects, keywords or tags for promotional material that may be associated with the virtual objects, etc.) that may be located within the immersive virtual reality world selected by the user. Video/audio stream 1612 may include data representative of content of the immersive virtual reality world other than virtual objects inserted into the world based on, for example, data included within metadata file 1610. For example, video/audio stream 1612 may include video and/or audio data related to real-world scenery content (e.g., a 360-degree image captured by a camera such as camera 102) of the immersive virtual reality world.

Media player device 1604 may receive, analyze, and/or otherwise use video/audio stream 1612 to present the immersive virtual reality world within a field of view for the user. In certain examples, virtual objects (e.g., virtual objects including promotional content platforms upon which promotional content is displayed) may be located at static locations within the immersive virtual reality world at which users will likely see the virtual objects and the promotional content but where the virtual objects and the promotional content may not be overly intrusive or distracting to the overall virtual reality experience of the user. For example, a virtual reality media content provider may track where various users experiencing an immersive virtual reality world tend to look and create a focus map (e.g., which may appear similar to a heat map) of the immersive virtual reality world representative of where user focus tends to be directed. Based on the focus map, the virtual reality media content provider may determine that placing a virtual object at a particular location (e.g., a location slightly below the user's line of sight if the user is looking straight ahead) will likely result in users seeing the virtual object (thus also seeing the promotional content mapped onto the virtual object) while not being overly distracted by the virtual object. In these examples, data related to the virtual objects may be static (e.g., programmed into software on media player device 1604, etc.) and may not utilize specific virtual object metadata such as may be included within metadata file 1610.

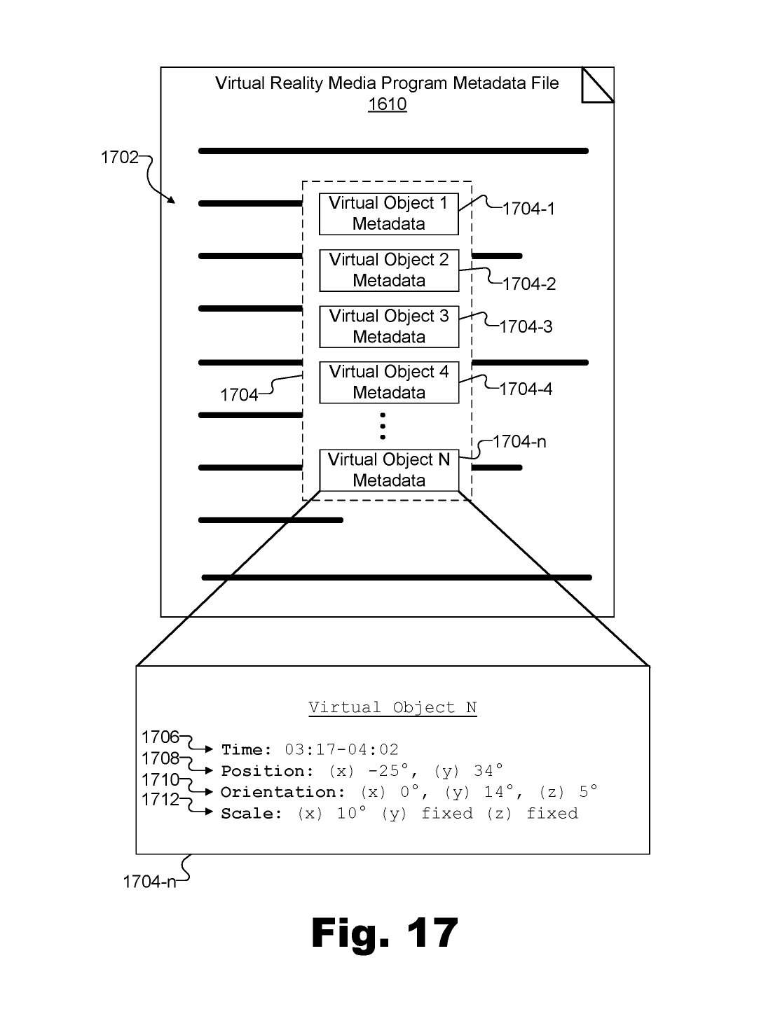

In other examples, metadata file 1610 may include metadata related to virtual objects that are dynamic and/or particular to the immersive virtual reality world, and that may be inserted at particular times and with particular display parameters into the immersive virtual reality world. To illustrate, FIG. 17 shows additional details for metadata file 1610 described above in relation to FIG. 16. As shown, metadata file 1610 may include data 1702 (e.g., textual data, metadata tags, markup code or other instructions, etc.) that may include metadata related to one or more virtual objects that have been or are to be inserted in the immersive virtual reality world. For example, as shown, metadata file 1610 may include data 1702 representative of virtual object metadata 1704 (e.g., virtual object metadata 1704-1 related to a first virtual object through virtual object metadata 1704-n related to an “nth” virtual object). Along with virtual object metadata 1704, data 1702 may include any other data (e.g., initialization data, metadata, advertising data, etc.) that backend system 1602 may transmit to media player device 1604 as may suit a particular implementation.

FIG. 17 further illustrates exemplary metadata that may be included within virtual object metadata 1704 (i.e., for the nth virtual object (“Virtual Object N”) associated with virtual object metadata 1704-n). Specifically, as shown, virtual object metadata 1704-n may include a time parameter 1706 that may indicate a time at which Virtual Object N may be displayed within the immersive virtual reality world. For example, time parameter 1706 indicates that Virtual Object N may be displayed within the immersive virtual reality world beginning 3 minutes and 17 seconds into the presentation of the immersive virtual reality world and ending 4 minutes and 2 seconds into the presentation of the immersive virtual reality world.

Virtual object metadata 1704-n may further include display parameters related to Virtual Object N such as a positional parameter 1708, an orientation parameter 1710, and a scale parameter 1712. These display parameters may be related to the display parameters described above in relation to virtual object 706 in FIG. 8. For example, positional parameter 1708 may represent positional parameters 806 shown in FIG. 8, orientation parameter 1710 may represent orientational parameters 808 shown in FIG. 8, and scale parameter 1712 may represent scaling parameter 810 shown in FIG. 8.

As shown, positional parameter 1708 may include both x and y components, which may be expressed in degrees in relation to axes of the immersive virtual reality world (e.g., axes 804 in FIG. 8). While only x and y components are illustrated, it will be understood that fewer or additional components (e.g., including a z component) may be used to describe the position of Virtual Object N in particular implementations.

Moreover, orientation parameter 1710 may include x, y, and z components also expressed in degrees in relation to axes of the immersive virtual reality world. Fewer or additional components may be used to describe the orientation of Virtual Object N in particular implementations.

Similarly, as shown, scale parameter 1712 may include x, y, and z components. As described above in relation to scaling parameter 810, one component (e.g., the x component) may be configurable while other components (e.g., the y component and the z component) may be fixed based on the configurable component such that the relative proportions of Virtual Object N may remain constant. In certain examples, each of the components of scale parameter 1712 may be independently configurable. Additionally, fewer or additional components may be used to describe the scale of Virtual Object N in particular implementations.

Media player device 1604 may receive metadata file 1610 in response to request 1608 and may use metadata file 1610 to present a user-selected immersive virtual reality world for experiencing by a user. Media player device 1604 may use the data included in metadata file 1610 in any suitable way to present the immersive virtual reality world. For example, media player device 1604 may use virtual object metadata to determine one or more operations to perform to access and map promotional content onto a virtual object. For instance, media player device 1604 may use virtual object metadata to determine time and display parameters for a virtual object, access promotional content that matches parameters of the virtual object, and map the promotional content to the virtual object in accordance with the parameters such that the promotional content is viewable within the immersive virtual reality world at an appropriate time and location.

In certain examples, metadata file 1610 may include data indicating a source from which to access promotional content (e.g., data indicating an HTTP call to be made by media player device 1604 to access promotional content from a source at a particular URL address) and/or data indicating one or more parameters (e.g., keywords, tags, etc.) that may be used to generate a request for promotional content having certain attributes (e.g., promotional content suitable for and/or related to certain demographics and/or virtual reality content).

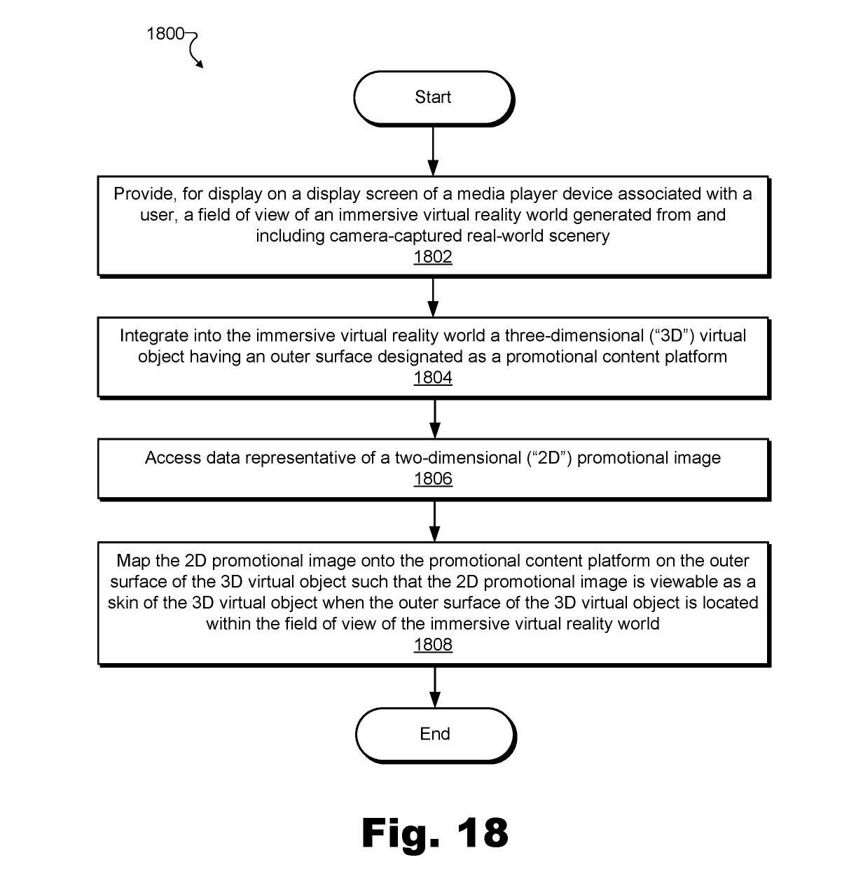

FIG. 18 illustrates an exemplary method 1800 of inserting promotional content into an immersive virtual reality world. While FIG. 18 illustrates exemplary operations according to one embodiment, other embodiments may omit, add to, reorder, and/or modify any of the operations shown in FIG. 18. One or more of the operations shown in FIG. 18 may be performed by system 400 and/or any implementation thereof.

In operation 1802, a virtual reality media system may provide for display on a display screen of a media player device associated with a user, a field of view of an immersive virtual reality world. In some examples, the immersive virtual reality world may be generated from and may include camera-captured real-world scenery. Additionally, the field of view may include content of the immersive virtual reality world and may dynamically change in response to user input provided by the user as the user experiences the immersive virtual reality world. Operation 1802 may be performed in any of the ways described herein.

In operation 1804, the virtual reality media system may integrate a three-dimensional (“3D”) virtual object having an outer surface designated as a promotional content platform into the immersive virtual reality world. Operation 1804 may be performed in any of the ways described herein.

In operation 1806, the virtual reality media system may access data representative of a two-dimensional (“2D”) promotional image. Operation 1806 may be performed in any of the ways described herein.

In operation 1808, the virtual reality media system may map the 2D promotional image onto the promotional content platform on the outer surface of the 3D virtual object. For example, the 2D promotional image may be mapped onto the promotional content platform such that the 2D promotional image is viewable as a skin of the 3D virtual object when the outer surface of the 3D virtual object is located within the field of view of the immersive virtual reality world, such as described herein.

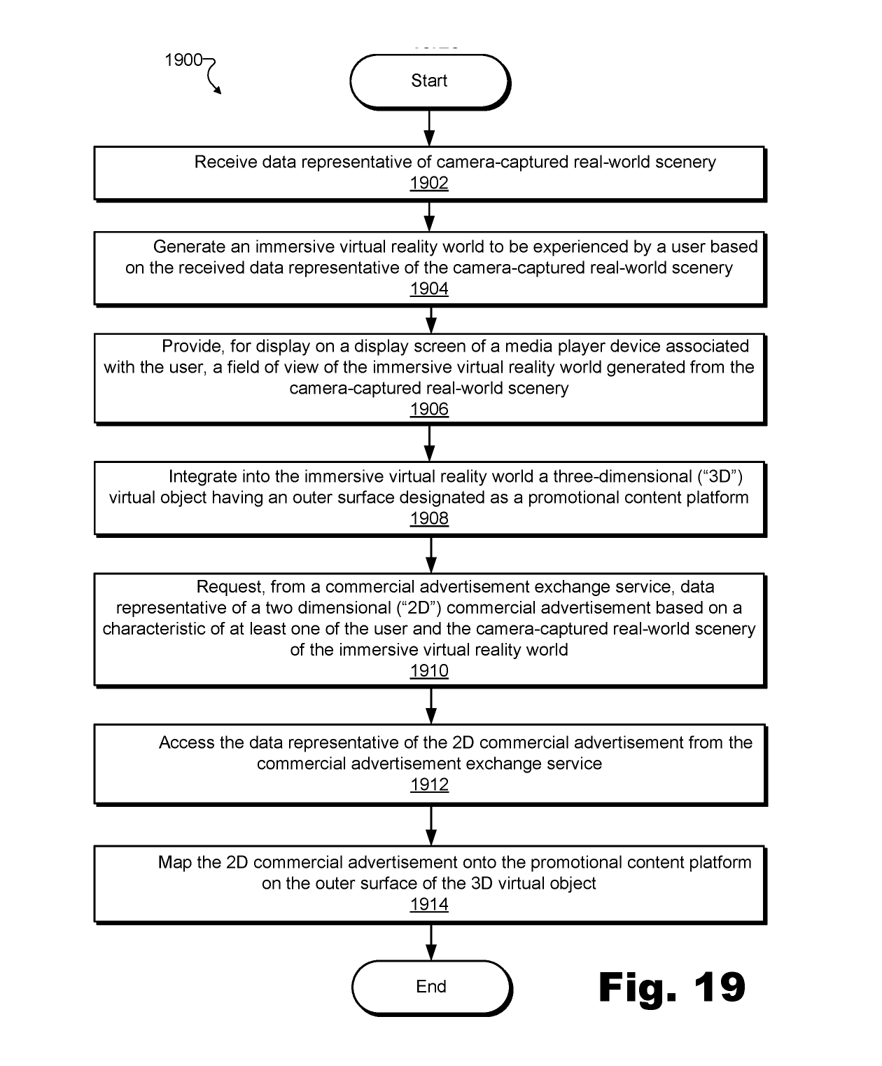

FIG. 19 illustrates an exemplary method 1900 of inserting promotional content into an immersive virtual reality world. While FIG. 19 illustrates exemplary operations according to one embodiment, other embodiments may omit, add to, reorder, and/or modify any of the operations shown in FIG. 19. One or more of the operations shown in FIG. 19 may be performed by system 400 and/or any implementation thereof.

In operation 1902, a virtual reality media system may receive data representative of camera-captured real-world scenery. For example, the data representative of the camera-captured real-world scenery may be captured by at least one video camera arranged to capture a 360-degree image of the real-world scenery around a center point corresponding to the video camera. The virtual reality media system may receive data representative of the camera-captured real-world scenery in any suitable way, such as by receiving raw pre-processed data from one or more video cameras or from another suitable source. Operation 1902 may be performed in any of the ways described herein.

In operation 1904, the virtual reality media system may generate an immersive virtual reality world to be experienced by a user. In operation 1904, the immersive virtual reality world may be generated based on the data representative of the camera-captured real-world scenery received in operation 1902. Operation 1904 may be performed in any of the ways described herein.

In operation 1906, the virtual reality media system may provide for display on a display screen of a media player device associated with a user a field of view of the immersive virtual reality world generated in operation 1904. The field of view may include content of the immersive virtual reality world and may dynamically change in response to user input provided by the user as the user experiences the immersive virtual reality world. Operation 1906 may be performed in any of the ways described herein.

In operation 1908, the virtual reality media system may integrate into the immersive virtual reality world a three-dimensional (“3D”) virtual object having an outer surface designated as a promotional content platform. Operation 1908 may be performed in any of the ways described herein.

In operation 1910, the virtual reality media system may request, from a commercial advertisement exchange service configured to distribute two-dimensional (“2D”) commercial advertisements, data representative of a 2D commercial advertisement. In some examples, the virtual reality media system may perform the request of operation 1910 based on a characteristic of at least one of the user and the camera-captured real-world scenery of the immersive virtual reality world. Operation 1910 may be performed in any of the ways described herein.

In operation 1912, the virtual reality media system may access the data representative of the 2D commercial advertisement that was requested in operation 1910 from the commercial advertisement exchange service. Operation 1912 may be performed in any of the ways described herein.

In operation 1914, the virtual reality media system may map the 2D commercial advertisement onto the promotional content platform on the outer surface of the 3D virtual object based on the data representative of the 2D commercial advertisement accessed in operation 1912. In some examples, the virtual reality media system may map the 2D commercial advertisement onto the promotional content platform such that the 2D commercial advertisement is viewable as a skin of the 3D virtual object when the outer surface of the 3D virtual object is located within the field of view of the immersive virtual reality world. Operation 1914 may be performed in any of the ways described herein.

In certain embodiments, one or more of the systems, components, and/or processes described herein may be implemented and/or performed by one or more appropriately configured computing devices. To this end, one or more of the systems and/or components described above may include or be implemented by any computer hardware and/or computer-implemented instructions (e.g., software) embodied on at least one non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

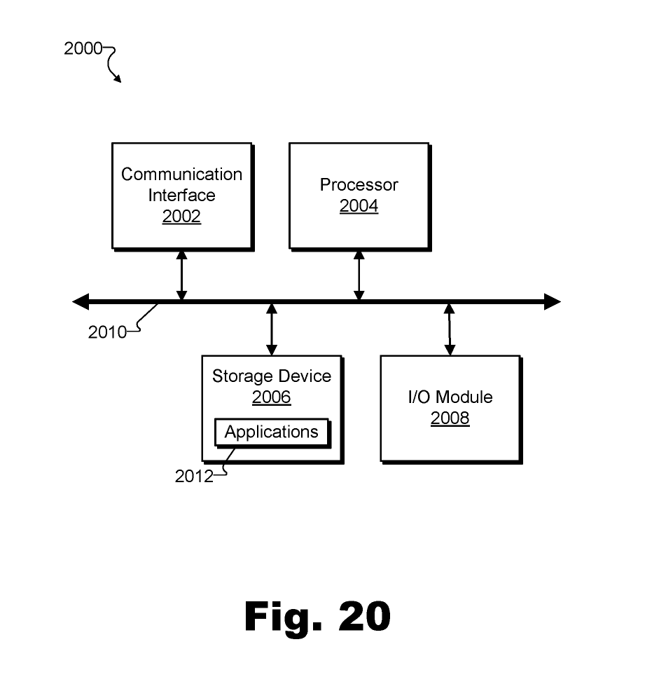

FIG. 20 illustrates an exemplary computing device 2000 that may be specifically configured to perform one or more of the processes described herein. As shown in FIG. 20, computing device 2000 may include a communication interface 2002, a processor 2004, a storage device 2006, and an input/output (“I/O”) module 2008 communicatively connected via a communication infrastructure 2010. While an exemplary computing device 2000 is shown in FIG. 20, the components illustrated in FIG. 20 are not intended to be limiting. Additional or alternative components may be used in other embodiments. Components of computing device 2000 shown in FIG. 20 will now be described in additional detail.

Communication interface 2002 may be configured to communicate with one or more computing devices. Examples of communication interface 2002 include, without limitation, a wired network interface (such as a network interface card), a wireless network interface (such as a wireless network interface card), a modem, an audio/video connection, and any other suitable interface.

Processor 2004 generally represents any type or form of processing unit capable of processing data or interpreting, executing, and/or directing execution of one or more of the instructions, processes, and/or operations described herein. Processor 2004 may direct execution of operations in accordance with one or more applications 2012 or other computer-executable instructions such as may be stored in storage device 2006 or another computer-readable medium.

Storage device 2006 may include one or more data storage media, devices, or configurations and may employ any type, form, and combination of data storage media and/or device. For example, storage device 2006 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 2006. For example, data representative of one or more executable applications 2012 configured to direct processor 2004 to perform any of the operations described herein may be stored within storage device 2006. In some examples, data may be arranged in one or more databases residing within storage device 2006.

I/O module 2008 may include one or more I/O modules configured to receive user input and provide user output. One or more I/O modules may be used to receive input for a single virtual reality experience. I/O module 2008 may include any hardware, firmware, software, or combination thereof supportive of input and output capabilities. For example, I/O module 2008 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 2008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 2008 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 2000. For example, one or more applications 2012 residing within storage device 2006 may be configured to direct processor 2004 to perform one or more processes or functions associated with communication facility 402, object integration facility 404, and/or virtual reality media content presentation facility 406. Likewise, storage facility 408 may be implemented by or within storage device 2006.

To the extent the aforementioned embodiments collect, store, and/or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
providing, by a virtual reality media system for display on a display screen of a media player device associated with a user, a field of view of an immersive virtual reality world generated from and including camera-captured real-world scenery, wherein the field of view includes content of the immersive virtual reality world and dynamically changes in response to user input provided by the user as the user experiences the immersive virtual reality world;
integrating, by the virtual reality media system into the immersive virtual reality world, a three-dimensional (“3D”) virtual object having an outer surface designated as a promotional content platform;
accessing, by the virtual reality media system, data representative of a two-dimensional (“2D”) promotional image; and
mapping, by the virtual reality media system, the 2D promotional image onto the promotional content platform on the outer surface of the 3D virtual object such that the 2D promotional image is viewable as a skin of the 3D virtual object when the outer surface of the 3D virtual object is located within the field of view of the immersive virtual reality world.

2. The method of claim 1, wherein the outer surface of the 3D virtual object designated as the promotional content platform is a planar surface.

3. The method of claim 1, wherein the mapping of the 2D promotional image onto the promotional content platform on the outer surface of the 3D virtual object comprises graphically distorting at least a portion of the 2D promotional image that is mapped to the promotional content platform.

4. The method of claim 1, wherein the integrating of the 3D virtual object into the immersive virtual reality world includes assigning the 3D virtual object a plurality of display parameters used to determine an appearance of the 3D virtual object to the user as the user experiences the immersive virtual reality world through the field of view, the plurality of display parameters including:
a positional parameter determinative of a location of the 3D virtual object within the immersive virtual reality world;
an orientational parameter determinative of an orientation of the 3D virtual object within the immersive virtual reality world;
a scaling parameter determinative of an apparent size of the 3D virtual object within the immersive virtual reality world; and
a time parameter determinative of a time period during which the 3D virtual object is viewable within the immersive virtual reality world.

5. The method of claim 4, wherein at least one of the display parameters assigned to the 3D virtual object dynamically changes as the user experiences the immersive virtual reality world such that the 3D virtual object appears to the user to move within the immersive virtual reality world.

6. The method of claim 1, wherein:
the 2D promotional image is a commercial advertisement associated with a commercial sponsor providing commercial support for the immersive virtual reality world;
the accessing of the data representative of the 2D promotional image includes requesting the commercial advertisement from a commercial advertisement exchange service configured to distribute 2D commercial advertisements; and
the requesting of the commercial advertisement is based on a characteristic of at least one of the user and the camera-captured real-world scenery of the immersive virtual reality world.

7. The method of claim 6, wherein the 2D promotional image includes video content and the method further comprises:
detecting, by the virtual reality media system subsequent to the mapping of the 2D promotional image onto the promotional content platform, that the promotional content platform is located within the field of view; and
playing back, by the virtual reality media system in response to the detecting that the promotional content platform is located within the field of view, the video content for viewing by the user on the promotional content platform located within the field of view.

8. The method of claim 7, wherein the 2D promotional image further includes audio content associated with the video content and the method further comprises:
playing back, by the virtual reality media system along with the playing back of the video content, the audio content associated with the video content.

9. The method of claim 7, wherein the playing back of the video content for viewing by the user includes dimming a portion of the content of the immersive virtual reality world included within the field of view during the playback of the video content, the dimmed portion of the content including at least some content within the field of view other than the video content being played back on the promotional content platform.

10. The method of claim 1, further comprising:
receiving, by the virtual reality media system, data representative of the camera-captured real-world scenery, the data representative of the camera-captured real-world scenery captured by at least one video camera arranged to capture a 360-degree image of the real-world scenery around a center point corresponding to the video camera; and
generating, by the virtual reality media system based on the received data representative of the camera-captured real-world scenery, the immersive virtual reality world.

11. The method of claim 1, embodied as computer-executable instructions on at least one non-transitory computer-readable medium.

12. A method comprising:
receiving, by a virtual reality media system, data representative of camera-captured real-world scenery, the data representative of the camera-captured real-world scenery captured by at least one video camera arranged to capture a 360-degree image of the real-world scenery around a center point corresponding to the video camera;
generating, by the virtual reality media system based on the received data representative of the camera-captured real-world scenery, an immersive virtual reality world to be experienced by a user;
providing, by the virtual reality media system for display on a display screen of a media player device associated with the user, a field of view of the immersive virtual reality world generated from the camera-captured real-world scenery, wherein the field of view includes content of the immersive virtual reality world and dynamically changes in response to user input provided by the user as the user experiences the immersive virtual reality world;
integrating, by the virtual reality media system into the immersive virtual reality world, a three-dimensional (“3D”) virtual object having an outer surface designated as a promotional content platform;
requesting, by the virtual reality media system from a commercial advertisement exchange service configured to distribute two-dimensional (“2D”) commercial advertisements, data representative of a 2D commercial advertisement, the requesting based on a characteristic of at least one of the user and the camera-captured real-world scenery of the immersive virtual reality world;
accessing, by the virtual reality media system from the commercial advertisement exchange service in response to the requesting, the data representative of the 2D commercial advertisement; and
mapping, by the virtual reality media system in response to the accessing and based on the data representative of the 2D commercial advertisement, the 2D commercial advertisement onto the promotional content platform on the outer surface of the 3D virtual object such that the 2D commercial advertisement is viewable as a skin of the 3D virtual object when the outer surface of the 3D virtual object is located within the field of view of the immersive virtual reality world.

13. The method of claim 12, embodied as computer-executable instructions on at least one non-transitory computer-readable medium.

14. A system comprising:
at least one physical computing device that:
provides, for display on a display screen of a media player device associated with a user, a field of view of an immersive virtual reality world generated from and including camera-captured real-world scenery, wherein the field of view includes content of the immersive virtual reality world and dynamically changes in response to user input provided by the user as the user experiences the immersive virtual reality world;
integrates, into the immersive virtual reality world, a three-dimensional (“3D”) virtual object having an outer surface designated as a promotional content platform;
accesses data representative of a two-dimensional (“2D”) promotional image; and
maps the 2D promotional image onto the promotional content platform on the outer surface of the 3D virtual object such that the 2D promotional image is viewable as a skin of the 3D virtual object when the outer surface of the 3D virtual object is located within the field of view of the immersive virtual reality world.

15. The system of claim 14, wherein the mapping of the 2D promotional image onto the promotional content platform on the outer surface of the 3D virtual object comprises graphically distorting at least a portion of the 2D promotional image that is mapped to the promotional content platform.

16. The system of claim 14, wherein the integration of the 3D virtual object into the immersive virtual reality world includes an assignment to the 3D virtual object of a plurality of display parameters used to determine an appearance of the 3D virtual object to the user as the user experiences the immersive virtual reality world through the field of view, the plurality of display parameters including:
a positional parameter determinative of a location of the 3D virtual object within the immersive virtual reality world;
an orientational parameter determinative of an orientation of the 3D virtual object within the immersive virtual reality world;
a scaling parameter determinative of an apparent size of the 3D virtual object within the immersive virtual reality world; and
a time parameter determinative of a time period during which the 3D virtual object is viewable within the immersive virtual reality world.

17. The system of claim 14, wherein:
the 2D promotional image is a commercial advertisement associated with a commercial sponsor providing commercial support for the immersive virtual reality world;
the at least one physical computing device accesses the data representative of the 2D promotional image by requesting the commercial advertisement from a commercial advertisement exchange service configured to distribute 2D commercial advertisements; and
the requesting of the commercial advertisement is based on a characteristic of at least one of the user and the camera-captured real-world scenery of the immersive virtual reality world.

18. The system of claim 14, wherein the 2D promotional image includes video content and the at least one physical computing device further:
detects, subsequent to the mapping of the 2D promotional image onto the promotional content platform, that the promotional content platform is located within the field of view; and
plays back, in response to the detection that the promotional content platform is located within the field of view, the video content for viewing by the user on the promotional content platform located within the field of view.

19. The system of claim 18, wherein the 2D promotional image further includes audio content associated with the video content and the at least one physical computing device further plays back, along with the playback of the video content, the audio content associated with the video content.

20. The system of claim 14, where the at least one physical computing device further:
receives data representative of the camera-captured real-world scenery, the data representative of the camera-captured real-world scenery captured by at least one video camera arranged to capture a 360-degree image of the real-world scenery around a center point corresponding to the video camera; and
generates, based on the received data representative of the camera-captured real-world scenery, the immersive virtual reality world.
